(19) United States
(12) Patent Application Publication
(10) Pub. No.: US 2008/0263633 A1
(43) Pub. Date: Oct. 23, 2008

(54) Systems and Methods of Network Operation and Information Processing, Including Data Acquisition, Processing and Provision and/or Interoperability Features

(76) Inventors: Jasminder Banga, San Francisco, CA (US); Nitin Shah, Cupertino, CA (US); Brijesh Patel, Gilroy, CA (US); Amul Patel, Pacifica, CA (US)

Correspondence Address: DLA PIPER US LLP, 2000 UNIVERSITY AVENUE, E. PALO ALTO, CA, 94303-2248, US

(21) Appl. No.: 12/088,236

(22) PCT Filed: Sep. 28, 2006
(86) PCT No.: PCT/US06/38186

§ 371 Date: May 28, 2008

Related U.S. Application Data
(60) Provisional application No. 60/721,711, filed on Sep. 28, 2005.

(51) Int. Cl. G06F 15/16; G06F 21/00

(52) U.S. Cl. 726/3; 709/217

(57) ABSTRACT

According to some embodiments of the present invention, a system, apparatus and method of network operation and information processing, including data acquisition, data processing, data provision, and/or data interoperability features is presented. In some exemplary embodiments, the method includes registering users logging-on to a computer network and gathering user-related information from users. In one or more embodiments, user-profile and location-centric information for each user may be gathered and/or processed in connection with processing targeting and content information.

### BACKGROUND

1. Technological Field

The present invention relates generally to systems and methods for network operation and information processing, and more specifically to such systems and methods directed to data acquisition, processing, provision, and/or interoperability features.

2. Description of Related Art

The emergence of the World Wide Web (“the Web”) over the past decade has spawned a teeming online community of Internet users drawn by the rich interactive multimedia content available on the web, and by the ease of transacting business online. To a large extent, the proliferation of commercial activities on the Web (“E-commerce”) has been driven by exclusively online or virtual retailers and, more recently, by the online presence of traditional “brick and mortar” stores.

Typically, Internet users obtain information from content-rich sites on the web such as news related sites, or portals, which offer links to sites that offer the content users are seeking, or through search engines that scour the web to glean the information users seek. Web sites often place markers called “cookies” on users computers based on the content viewed. In one such known method, cookies may then be read and updated to build a user profile.

Although cookies may be used to deliver targeted content, this approach has several drawbacks related to one facet of the present invention. First, a site can only use the cookies that it sets to target visitors to its site. This leads to a rather compartmentalized view of a user based on the site's limited past experience with the user. Next, the user must visit the site that set the cookie before it can be read to deliver any targeted content. Finally, with the rapid upsurge and continued growth in mobile computing, user-profile related information stored in a cookie might be irrelevant or hopelessly inaccurate. For example, geographic location information about a user may change quickly. Thus, displaying an advertisement for a store in New Orleans, La. may be a waste of server resources if the user is currently in Paris, France. On the other hand, the advertising may be extremely effective if the advertising was directed to Cajun or Creole restaurants in Paris, France. Making such content delivery decisions requires website-independent user-related information that is dynamically updateable and usable in real-time.

To compound the problems facing advertising content deliverers, Internet users are becoming increasingly unreceptive to traditional advertising techniques such as banners or pop-up windows. Thus, advertisers are resorting to more content-rich advertising, where advertising is done more suggestively through content-placement at strategic points in the presentation. Content-rich advertising is effective but demands greater data bandwidth thus leaving less time for content deliverers to process user-profile related information and make real-time targeting decisions. Moreover, with increasing concerns about privacy and data security a large number of users routinely delete cookies and other tracking information stored on their computers making such targeting decisions difficult, if not impossible. As a result, content servers have resorted to a fixed pool of content that is served up to website-users round robin with little or no effort directed at targeting.

Revenue streams for advertising content deliverers are oftentimes based on click-through rates by users. In other words, the revenue stream often depends on the number of users responding to an advertisement rather than the raw number of advertisements served to users. Thus, on one hand the untargeted round robin delivery scheme limits the number and types of advertisements within a pool because each advertisement is served to a large number of users. On the other hand, advertisers lose revenue because untargeted advertising will generally result in lower click-through rates.

Wireless Access Points (“AP”) offer an approach to target a diverse group of mobile users. APs provide a gateway for mobile computing users to access the web and may also be able to provide location specific information to advertisers. However, such access points have hitherto been difficult and expensive to deploy. Moreover, current implementations do not offer the extensive data gathering and information processing capabilities required for the targeted delivery of content.

In general, traditional methods and systems for the delivery of content to users make broad website-specific static generalizations regarding user profile and behavior and thus are incapable of intelligent adaptive real-time delivery of targeted content. Moreover, even when data such as location-related data is available, current methods require complex correlations of disparate databases. Such correlations result in significant delay and degradation of performance so that end-users cannot get timely information pertinent to their location. Because of these limitations, content and service providers also face a barrier. If the performance is limited, and if the range of devices and locations is limited, service providers cannot ensure providing a uniform level of service to users. Thus, mass-market deployment with a priori knowledge that the service cannot serve many elements of the market is both infeasible and prohibitively expensive.

There is therefore a need for efficient, easy to deploy, adaptive learning methodologies and systems that build website-independent user-profile related information, and that are capable of updating, adaptively processing and delivering targeted content in real-time to an increasingly mobile computing community.

### SUMMARY

In accordance with the present invention, systems and methods for network operation, information gathering and processing, and targeted content delivery including business models and/or advertising methodologies are presented.

According to some embodiments of the present invention, a system, apparatus, and method for targeted content delivery is presented. In some embodiments, the method comprises registering users logging-on to a computer network or any from of IP network, such as WiFi, WiMAX, DSL, Cable, IPTV etc, WiMAX, DSI, Cable, IPTV, Internet Video network and gathering user-related information from users. Location-centric information for each user logged-on to the network is relayed to a server, and user-profile information for each user is retrieved from a database. In some embodiments, if a user-profile is not present in the database, a new entry and profile-information may be created in the database. User-profile and location-centric information for each user is processed to get targeting information for each user and the targeting information is sent to a content-provider wherein the content-provider uses the targeting information to select content to be displayed to users. In some embodiments, user-profile and location-centric information may be gathered from wireless access points to which users log-on in order to access the Internet. In some embodiments, the wireless network may be publicly accessible. profile data and information
a. profiles may be based on a wide variety of parameters
   i. Technographic information gathered about the device, and total amount of data transacted (uplink/downlink) in a session and therefore a wide range of information about the device and its behavior and user, which provides a “fingerprint” of the device (e.g. browser type, browser install date, screen size, operating system etc)
   ii. Geographic information gathered by the network about the device's current location as well as its historical data of prior locations and therefore a “geo/location tag”
   iii. Chronographic information, which is the time of day/date for the user arriving on the network, as well as duration of the Internet session, and historical data on locations and times of prior accesses or entries into the network, and therefore a “frequency/duration tag”
   iv. demographic information gathered from the:
      1. Network operator (stripped of PII—personally identifiable information) for example Male, 25-30 years old, income less than $75 k
      2. User input: surveys, incentives, and customization.
      3. Advertiser stats, data etc. Example, online advertising company that has existing information about a customer example—cookies, anonymous purchase statistics, brand preferences etc.
   v. Psychographic (Psychographics is a form of social group analysis that studies how people react to the world around them according to their values and lifestyles) this information could be provided by advertisers, destination sites, combination of user input with advertiser info (who know the user well over time)

Methods according to some embodiments of the invention also relate to the targeted delivery of commercial content and increasing the inventory of commercial content available for delivery by web site operators. In some embodiments, a large inventory of targetable content is stored on a server and targeting information pertaining to users is received and correlated with the targetable content. In some embodiments, targetable content is then selected for display on the user's browser based on the correlation between targeting information received for that user and the targetable content. In some embodiments, the targetable content selected for display on the user's browser may be modified prior to being displayed based on user-preferences or other criteria. In some embodiments, the targetable content selected for display on the user's browser may be modified based on parameters of the display device being used by the web-site user.

Presentation of the data:

The data gathered can be sent in a raw, explicit form to the advertising and search and content providers, however this is rarely required or warranted.

The clustering of the data according to industry standard practices is the format which is used to “pre-launch” the database into a compact and yet meaningful meta-data set, which is updated over time, but is also available at any point to launch to the advertising or search or content networks.

Clustering is done with multiple filters, based on both the contractual business relationship established with the receiver of the information, as well as the ability to manage, refresh, update and analyze the data gathered.

For example, if an advertiser is interested in a campaign to broadcast a particular advertisement for a brand across a particular demographic or particular market on a particular Friday afternoon, instead of choosing, say sports-oriented TV channels, they can choose sports publishers (websites), and run the campaign only in a particular geographic market at that particular time. This allows the advertiser to buy a large footprint across a whole geographic market across multiple publishers, which is not possible on the Internet today.

The type of clustering used for this would be filter such as “male, age range 25 to 40 in Chicago and the surrounding suburbs, except for regions where average family incomes are below $35,000 per annum”. This parameter would be used to sort the database, and pre-select the target audience, so when that day and time arrives already there is a set of data in the database ready to deliver to one or more advertising networks, serving all the appropriate publishers for the message, but would only be applied to that market and to that criterion. This data can reside in the database, or be exported to the Advertising networks well before the event, so the advertisements are now in a “pre-triggered state”. In this state, since the relevant data is in the database of the advertiser, instead of sending a profile from the TTIP (trusted targeting information provider), all that is required is the association of a device arriving on the network and its session ID and IP address, and for that campaign, the advertiser can autonomously run the campaign, and release all the records and metrics back to the TTIP.

Analytics are delivered with multiple tiers of filtering and granularity (e.g. all people who have NOT been on the network in the past 12 hours, all males in a particular markets etc, all people who are frequent users of the network, and tend to be on the network in the afternoon, and are in a particular age group etc).

In some methods for targeted content delivery, the use of consumer related information gathered allows for an increase in the advertisement inventory available on an advertising server for targeted delivery to consumers. In some embodiments, such an increase in advertising inventory and content delivery may be accomplished with existing systems without associated increases in bandwidth requirements.

Cookies:

Cookies are the normal currency of the targeting of advertisements and content to individual machines (by the way, cookies also do not interact with individual users, only machines)

A very simple implementation of the system is to rely on the information already resident in the cookies and to associate them with the devices where they were deposited. Since cookie deletion is more of an issue of protecting an individual machine from violation, a mirror of the cookies are stored in a “network cookie”. This cookie may be also deleted by the user if requested, but since its properties are now changed from residing in the device to residing in the network, they have no ability to maliciously harm the end user device.

These and other embodiments are more fully described and their principles of operation explained in the following sections.

### BRIEF DESCRIPTION OF THE DRAWINGS

FIG. 1A shows a block diagram illustrating an exemplary system for targeted content delivery, according to one or more embodiments of the present invention.

FIG. 1B shows a block diagram illustrating the architecture of an exemplary platform for targeted content delivery, according to one or more embodiments of the present invention.

FIG. 1C illustrates information processing and delivery as previously known.

FIG. 1D illustrates one representative architecture for one or more exemplary targeted-advertising, targeted search and content delivery business methods/models, according to one or more embodiments of the present invention.

FIG. 1E illustrates another representative architecture for one or more exemplary targeted-advertising targeted search and content delivery business methods/models, according to one or more embodiments of the present invention.

FIG. 1F illustrates exemplary information processing and delivery, according to one or more embodiments of the present invention.

FIG. 1G illustrates additional exemplary information processing and delivery, according to one or more embodiments of the present invention.

FIG. 1H illustrates localized information storage and processing as previously known.

FIG. 1I illustrates some exemplary global information storage and transmission, according to one or more embodiments of the present invention.

FIGS. 1J and 1K show illustrations of a information processing feedback models, according to one or more embodiments of the present invention.

FIG. 1L illustrates some exemplary interactive survey/preference buttons, according to one or more embodiments of the present invention.

FIG. 1M shows a block diagram illustrating several exemplary AP server implementations according to some embodiments of the present invention.

FIG. 1N shows a diagram illustrating the integration of an exemplary XML gateway into the platform, according to some embodiments of the present invention.

FIG. 2 shows a flow chart illustrating an exemplary process for implementing network operation and information processing, according to some embodiments of the present invention.

FIG. 3 shows a flow chart illustrating an exemplary process for implementing network operation and information processing according to some embodiments of the present invention.

FIG. 4 shows a flow chart illustrating an exemplary process for implementing network operation and information processing according to some embodiments of the present invention.

FIG. 5 shows a flow chart illustrating an exemplary process for implementing network operation and information processing according to some embodiments of the present invention.

FIG. 6 shows a flow diagram illustrating an exemplary process for implementing network operation and information processing according to some embodiments of the present invention.

FIG. 7 shows a flow diagram illustrating an exemplary process for implementing network operation and information processing according to some embodiments of the present invention.

FIG. 8 shows a flow chart illustrating an exemplary process for implementing network operation and information processing according to some embodiments of the present invention.

FIG. 9 shows a flow diagram illustrating an exemplary process for implementing network operation and information processing according to one or more embodiments of the present invention.

FIG. 10 shows a flow diagram illustrating an exemplary process for implementing network operation and information processing according to one or more embodiments of the present invention.

FIG. 11A shows a chart noting current problems and opportunities in the online advertising space

FIG. 11B shows a chart noting current various business method/model considerations relating to online advertising targeted search and content delivery FIG. 11C shows a chart noting current problems and opportunities in the online advertising tracking and measurement

FIG. 11C shows opportunities in the tracking and spending of online advertisements across the web.

FIG. 11D shows a chart noting current problems and opportunities in the online advertising space

FIG. 11E shows a chart noting current problems and opportunities in the broadband and revenue space.

FIG. 12 illustrates traditional web-based advertising targeted search and content delivery methodology.

FIG. 13 illustrates a targeted advertising targeted search and content delivery methodology according to embodiments of the present invention.

FIG. 14 illustrates current advertising inventory or targeted content or search results targeted search and content delivery at a site using traditional web-based advertising methodologies.

FIGS. 15-20 illustrate systems and/or method of network operation and information processing consistent with one or more embodiments of the present invention.

FIG. 21 illustrates systems and/or methods of an enabler for tagging profiles consistent with one or more embodiments of the present invention.

FIG. 22 illustrates systems and/or methods of integration with Carriers networks consistent with one or more embodiments of the present invention.

### DETAILED DESCRIPTION

In accordance with the present invention, systems and methods for network operation, information gathering and processing, and targeted content delivery are presented. In some embodiments, the targeted content may include commercial and advertising information.

According to some embodiments of the present invention a “system in a box” solution for wireless access point deployment is presented. In some embodiments the system in a box solution could work with an existing access point to provide additional services and methods according to embodiments of the invention. In some embodiments, the system providing access point services gathers information related to devices and users using AP services, including user and device identification information, and browsing history related information. The gathered information is combined with location specific information and the combined information relayed to a server for storage in a database. In some embodiments with targeted content delivery, the system identifies users or devices when they seek access to AP services, may update location specific information in the database, and download user and/or device profile information to a network proximate cache for easier access. In some methods for targeted content delivery, user and device profile related information may be relayed to sites visited by the user to aid in the selection of commercial content. In some embodiments, commercial content information destined for a user may be reformatted, changed, or enhanced based on the device type utilized by the user. In some embodiments, site-specific templates pertaining to web pages may be stored on a server or accessed from a proximate network cache, and the templates used to modify or substitute commercial content based on user and/or device profile information before delivery to the user. In some methods, commercial content of the messages may be continuously adjusted based on user-interaction or receptivity to the commercial or advertisement or content or search keywords.

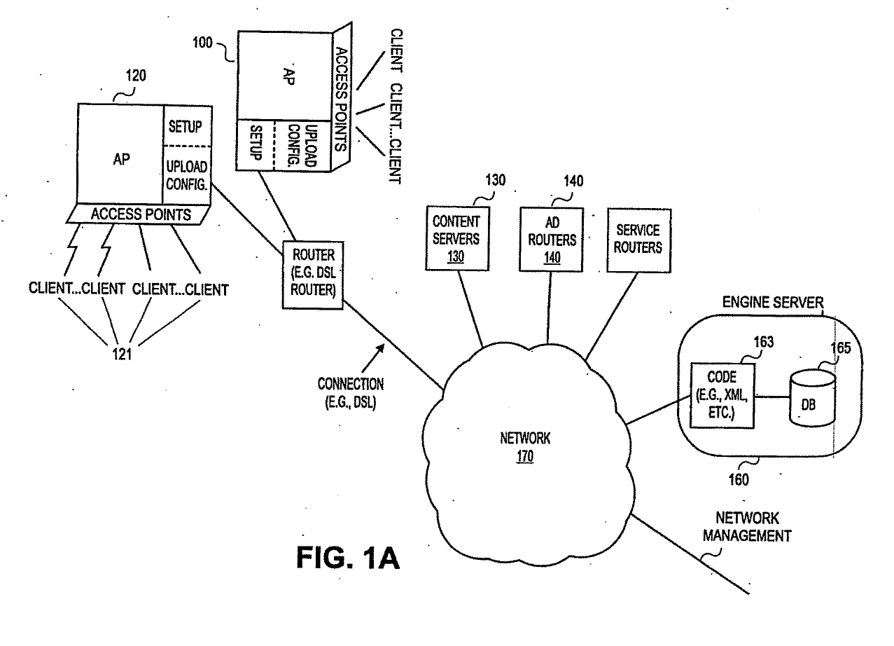

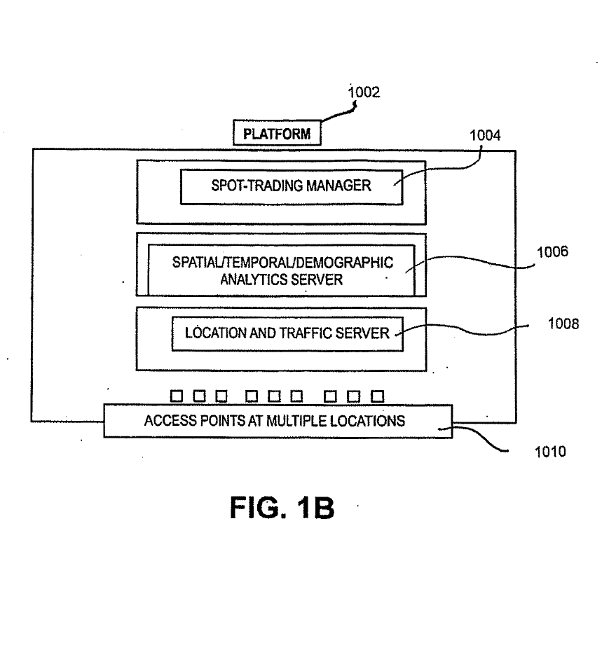

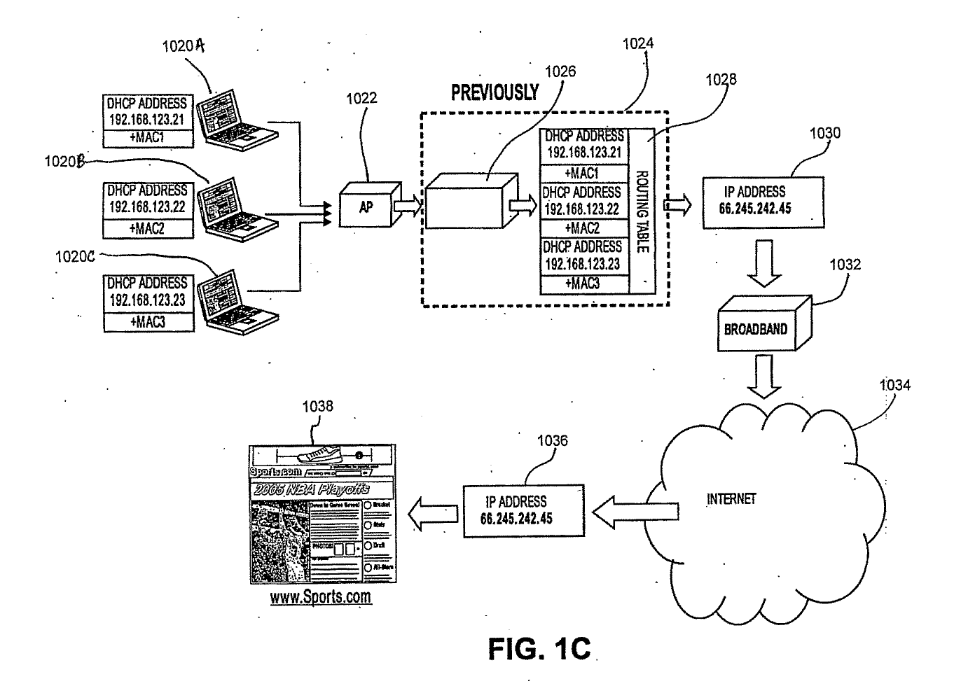

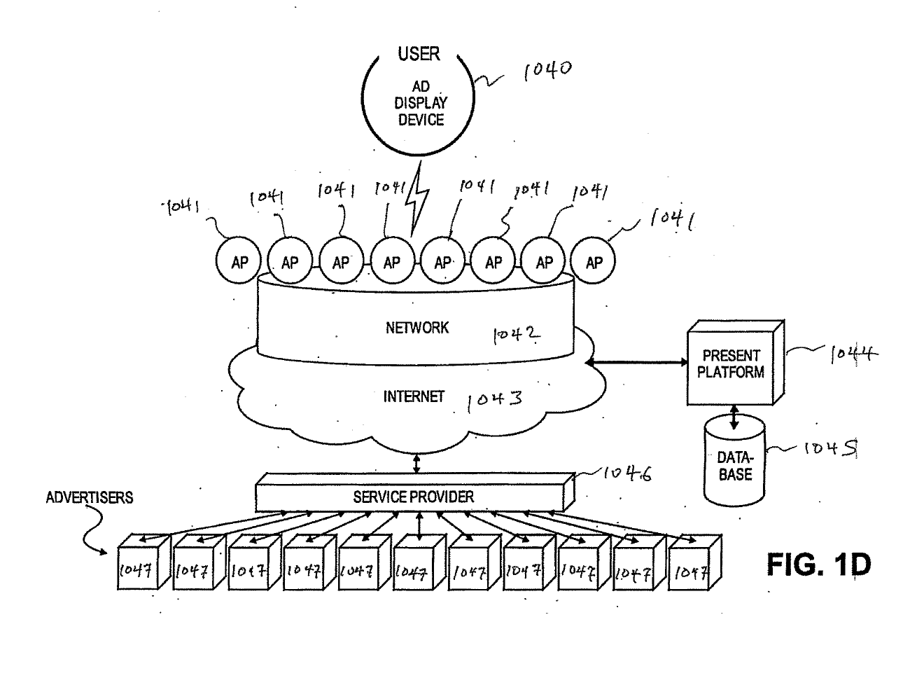

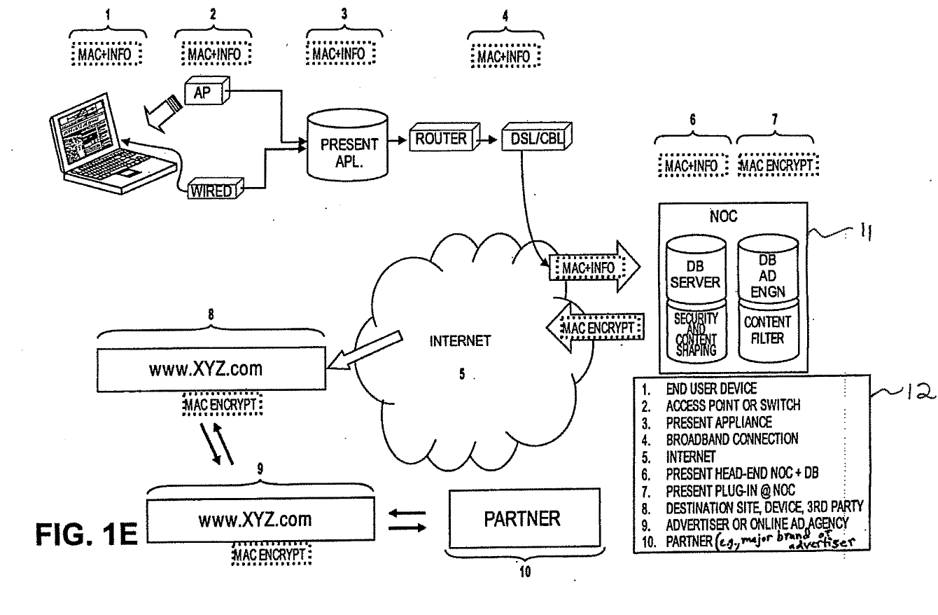

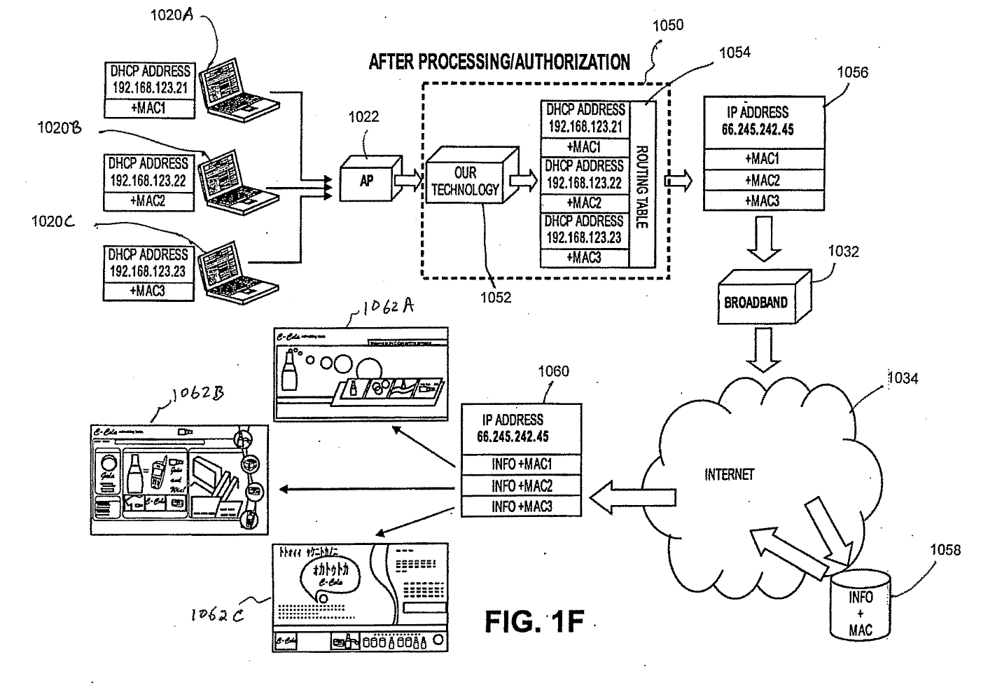

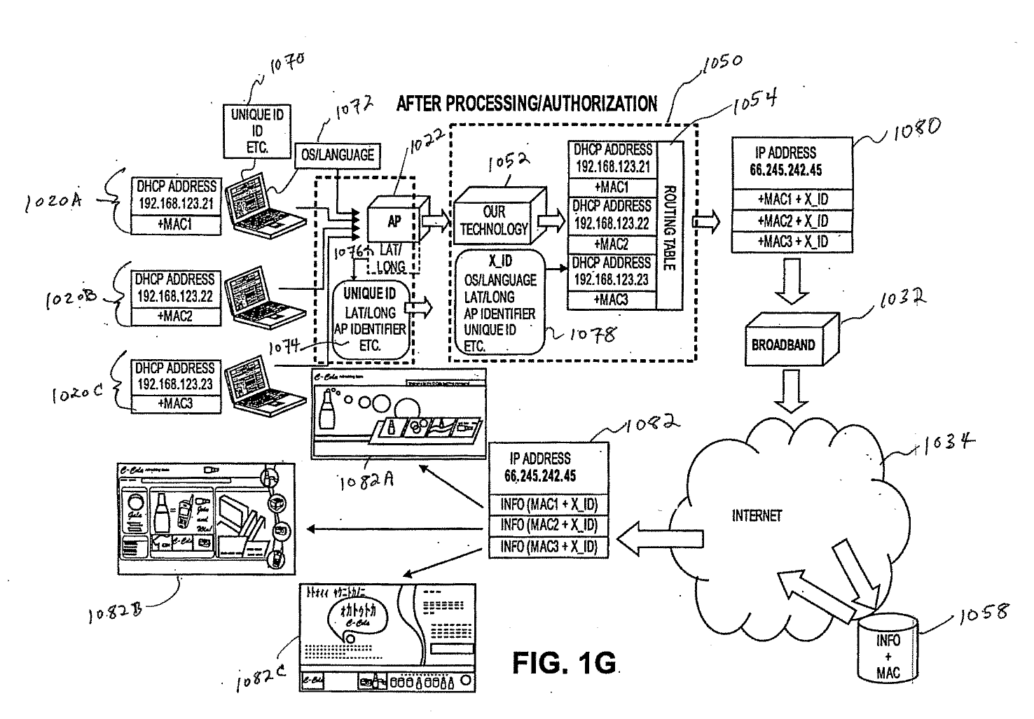

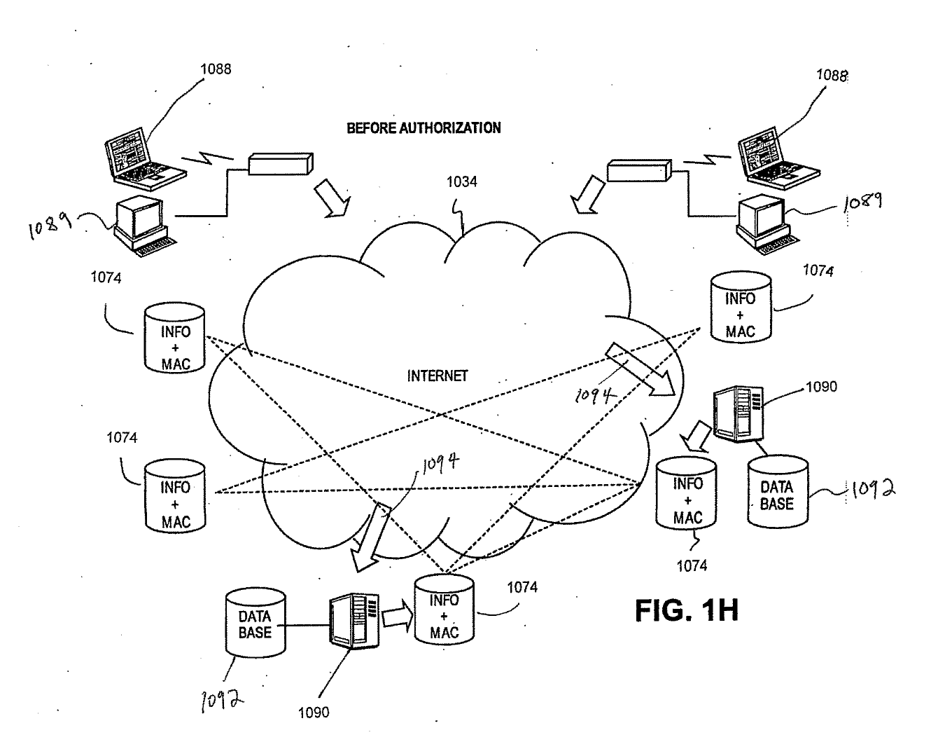

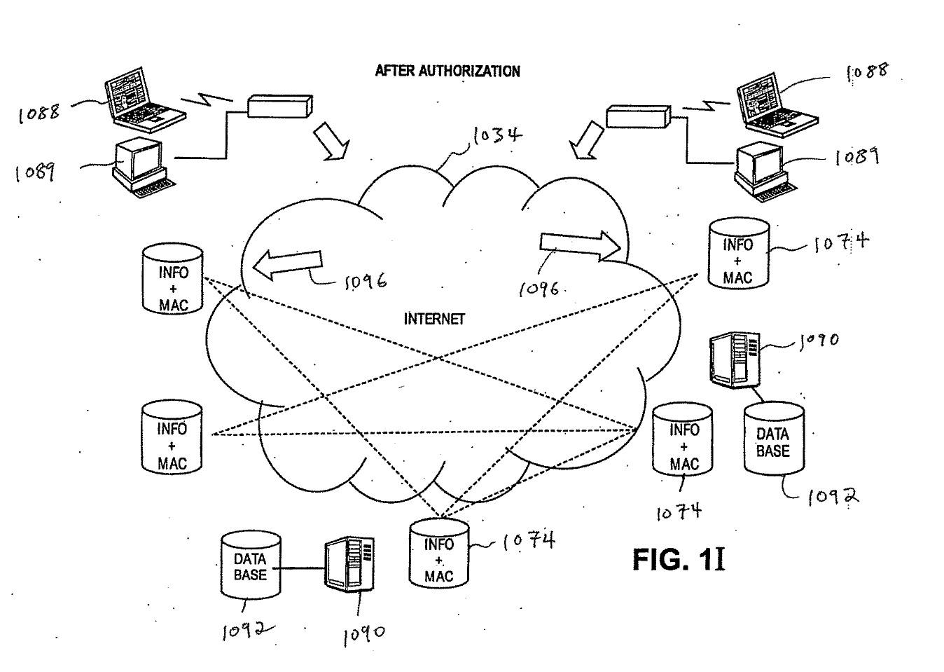

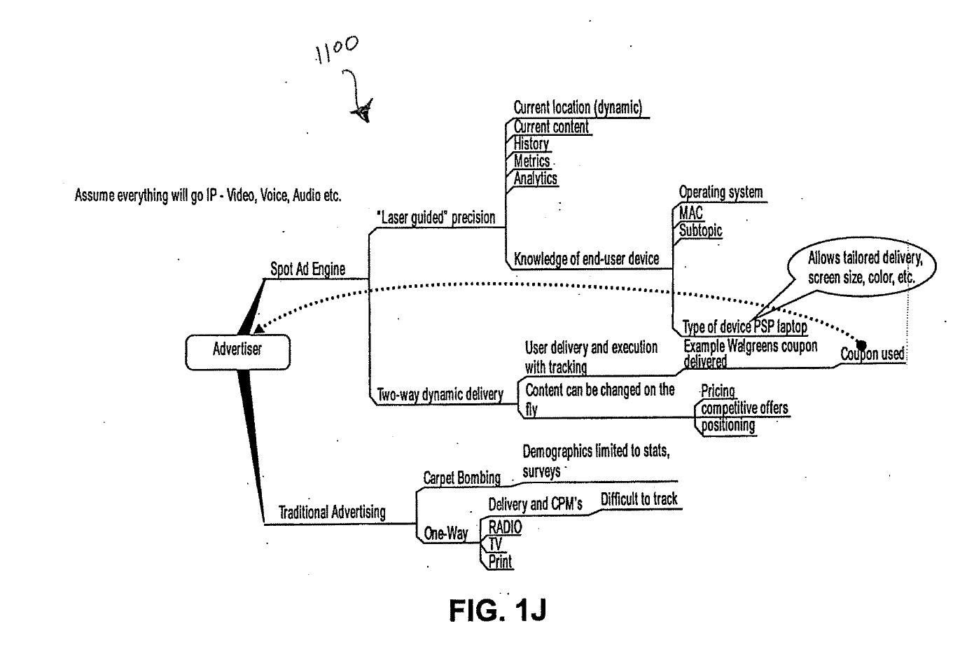

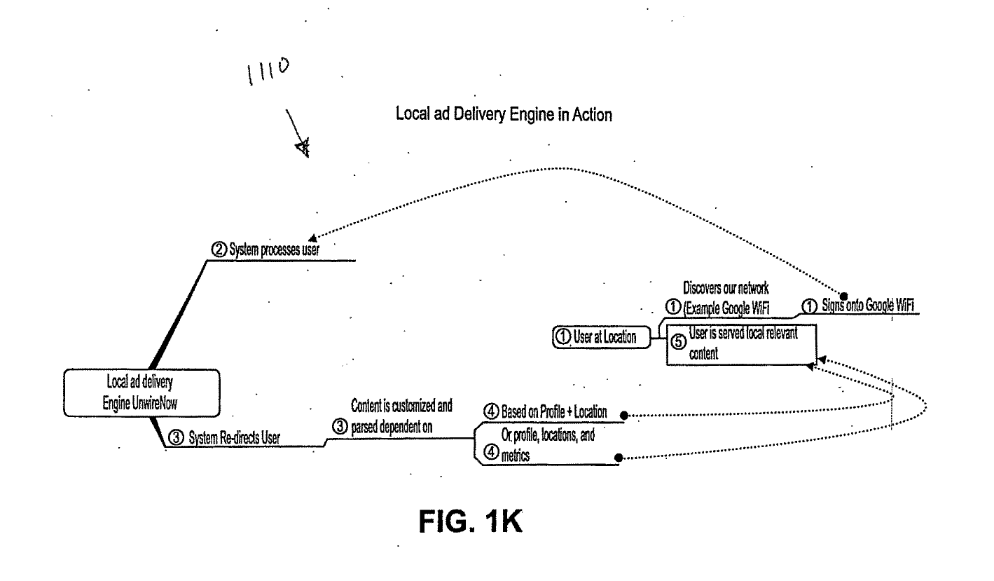

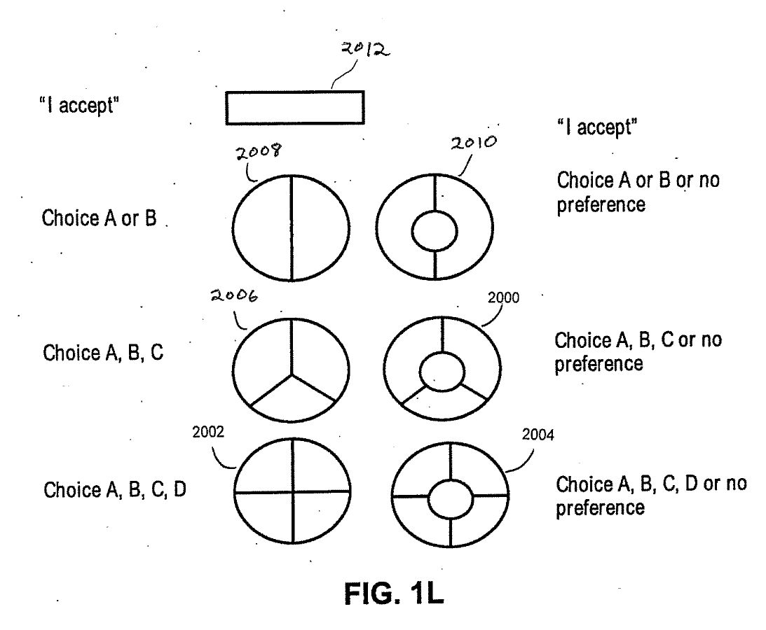

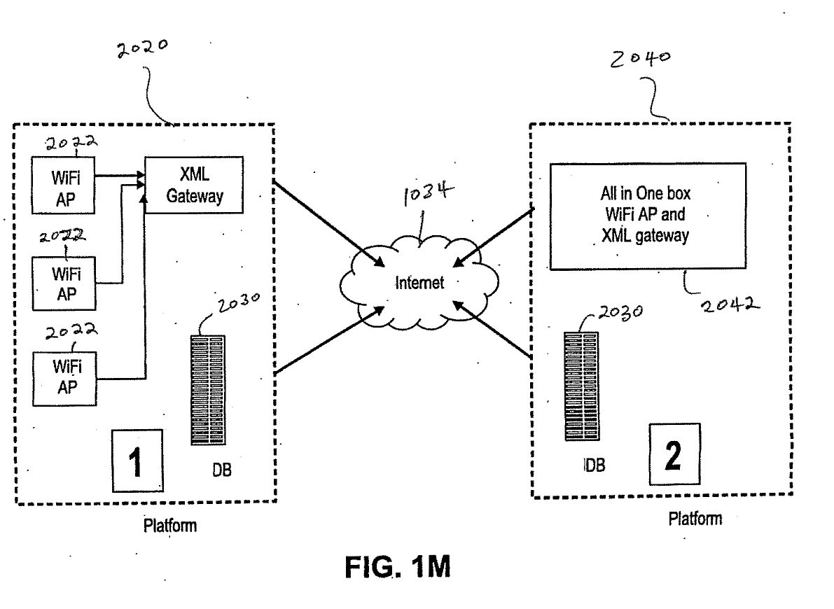

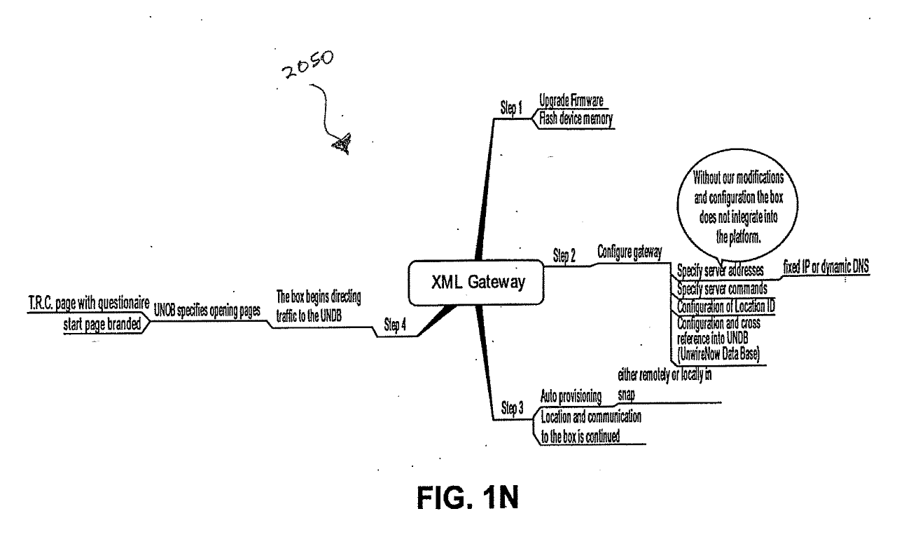

FIG. 1A depicts an exemplary system 100 consistent with one or more embodiments of the present invention. Components of system 100 can be implemented through any suitable combination of hardware, software, and/or firmware.

As shown in FIG. 1A, according to some embodiments of the present invention, system 100 can include the following exemplary system software and hardware. In some embodiments, the servers and related systems shown in FIG. 1A may be standard off-the-shelf components. For example, the Engine Server 160 of the present invention may include a database 165, which may use a Microsoft (“MS”) SQL Server, and/or other programs or code 163 to access and present information in the database. In some embodiments, systems may use languages such as SQL, XML, SOAP, ASP, and HTTP, etc. to perform tasks, although any suitable programming language or tool could also be used.

Information in database 165 is updated over network 170 using information gathered by AP server 120 from clients 110 connecting to AP server 120. In some embodiments AP server 120 may request user and device profile information from the UN Engine Server 160, if it determines that a particular user or device has accessed the system on a prior occasion. In some embodiments, user or device profile information may be downloaded to a proximate network cache (not shown) for quicker access. In some embodiments, according to the present invention multiple mirrored UN engine servers may be used and physically and geographically distributed over network 170. Network 170 could be a LAN, WAN or the Internet. In some embodiments, the AP server 120 may be a server according to the present invention that offers a system in a box solution. In some embodiments, AP server 120 could be used with existing AP systems such as remote wireless access point/servers from generic providers, for example, Proxim, Linksys, Dlink, Compex, Buffalo Technologies, Netgear, Terabeam, Nomadix, and Plug Inn Go, etc. In some embodiments, the targeted content delivery system may also be used or implemented with wired technology. Embodiments of the targeted content delivery system may also include signal amplifiers, external antennas, signal splitters, and other standard equipment as components.

In some embodiments, when an end-user browses web sites using a computing device, AP server 120 collects information regarding browsing habits and relays this information to UN Engine Server 160, where a database record for the user and/or device may be updated. In some embodiments, AP server may also download information from UN Engine Server 160 and modify and send some of this information to Content Server 130 and/or Ad Router 140. In some embodiments, user and/or device profile information received by Content Server 130 from AP Server 120 may be used by Content Server 130 to determine which advertisements or content or search results to retrieve from Ad Router 140. Content and advertising information are combined by Content Server 130 and sent to AP Server 120, which sends this to client 121. In some embodiments, AP Server 120 may modify the content or advertising received over the network 170 based on device characteristics. For example, if client 121 is a handheld device, the format of the content may be modified to better suit the screen and other characteristics of that handheld device.

The broader platform and location-centric functionality are now described in the context of the targeted content delivery system. In some embodiments, location-centric features may pertain to physical locations, such as any trafficked area including transportation centers, public parks and public outdoor areas, public indoor areas (such as libraries) and lobbies of hotels, malls, retail stores, eating places, rental centers, etc. According to embodiments of the invention, location-centric information is defined not only by a specific geographic location (e.g., latitude and longitude), but also by environment, such as areas of interest around the physical location. For example, tourist sites, eating places, hotels, shopping areas, entertainment areas, etc., may all be areas of interest regarding a location. In general, embodiments of the system may allow AP service providers using apparatus and/or methods of the present invention to configure portions of the AP server 120 with appropriate “areas of interest” data. Thus, embodiments of the present invention can include a catalog of all the potential action-related locations that the system provider may want in order to target users within a certain timeframe or distance from the location in question. In some embodiments, the present targeted content delivery system's “geo-targeting” of advertisements and content and search results may also include information closely related to the demographics of the location such as climate, weather, ethnic mix of the community etc., and extend beyond the use of simple numerical information such as population density. Such location-centric awareness permits advertisements, content or search results to be delivered and targeted to a community or a particular segment of the population.

The targeted content delivery system according to embodiments of the present invention is more effective than traditional advertising or content or search results, because the advertiser, coupon-deliverer, or information provider can adjust content in direct response to the measured response form the user. This is the first mechanism where the advertisements and content and search results can be made genuinely interactive with the user and with the financial model (i.e. revenue generation by the user acting on the information and physically turning up to a location to perform a transaction.) Moreover, here, the fulfillment of a service is not delayed by the fact that the product needs to be shipped or delivered to the user; rather the user is directed to the nearby location that provides the product. In order to exploit the advantages of embodiments of the present invention, a software architecture or software platform, for realizing embodiments of the invention, may structured as set forth in FIG. 1B.

The software components shown in FIG. 1B may be deployed on the Engine Server 160, or distributed across several physical computing devices which are connected by a network that permits data sharing. In some embodiments, for example, some or all of the functionality of the Location and Traffic Server may be distributed to AP Servers, such as AP server 120. In some embodiments, the exemplary software platform shown in FIG. 1B may contain additional components (not shown) to perform other functions, as may be described elsewhere in this documents. Such functions could include computational or analytical engines and/or other types of servers. In some embodiments, such components may be a part of the components shown in FIG. 1B.

In some embodiments, the location and traffic server shown in FIG. 1B manages the channel configuration and location and installation profiles of the all the APs already in service. The location and traffic server can also transact with each new AP Server, such as exemplary server 120, when it first is discovered on the network. In some embodiments, portions of the functionality of location and traffic server may be resident on AP Server 120. As each user enters a network at a particular location, the simplest function that the location and traffic server plays is to transfer that location information (i.e. a new user has entered the network at a particular place) so that this information can be delivered to a advertising or commercial content service provider (i.e. an applications interface which communicates with entities outside the targeted content delivery platform). The advertising or commercial content service provider then can perform whatever tasks it may want (e.g. display advertising, content etc. related to that particular location).

In some embodiments, a Spatial/Temporal/Demographic Analytics Server shown in FIG. 1B receives the location-centered data and information from the location and traffic server. This analytics server also receives information about the user from the location and traffic server. In some embodiments, user information may be altered to ensure privacy and anonymity, so as not to breach any privacy regulations that may be in effect, when this data is later shared with third parties.

In some embodiments, the Spatial/Temporal/Demographic Analytics Server may be part of Engine Server 160, where it may access database 165 as needed. At this point, the analytics server has a database not only of the locations of the APs and the activity at the APs of the clients, but also has residual demographic information, and current environmental information (such as weather, population densities), as well as information supplied by retailers or communities for special events, entertainment such as theater, plays, opera etc.

In some embodiments, the software platform may include a transaction/trading manager component as shown in FIG. 1B. The transaction/trading manager component presents an interface to those content providers (advertisers, event and conference holders etc) who would benefit from the fully interactive potential of the system. In some embodiments, the transaction/trading manager component may be part of Engine Server 160.

In some embodiments, the transaction/trading manager server has an external interface which can be driven either with an auction process or with pre-determined contractual processes, procedures, and rules to deliver specific types of content to users, based on some of the data supplied to the Analytics engine. For example, a pre-written contract with a soft drink manufacturer and a web site could trigger specific advertising content related to the soft drink to be delivered to users at any location in New York City where the local temperature in the City exceeds 90 degrees. By way of another example, a clothing retailer may have an agreement to advertise and supply coupons for rainwear when there is a weather forecast, which suggests rain in the window of the next 2-3 days.

Use of identifiers, unique identifiers such as MAC addresses and/or UIDs (Unique Identifiers) {referred to as “MAC/UID,” a term which also includes and any other unique software or hardware based IDs in the devices on the network}, and other information processing consistent with the present invention is next described. As background, previously known use of MAC addresses is illustrated in FIG. 1C. As shown in FIG. 1C, basic identifier information such as a MAC address might initially be known, but it is lost at the routing stage and does not factor in to later network processing.

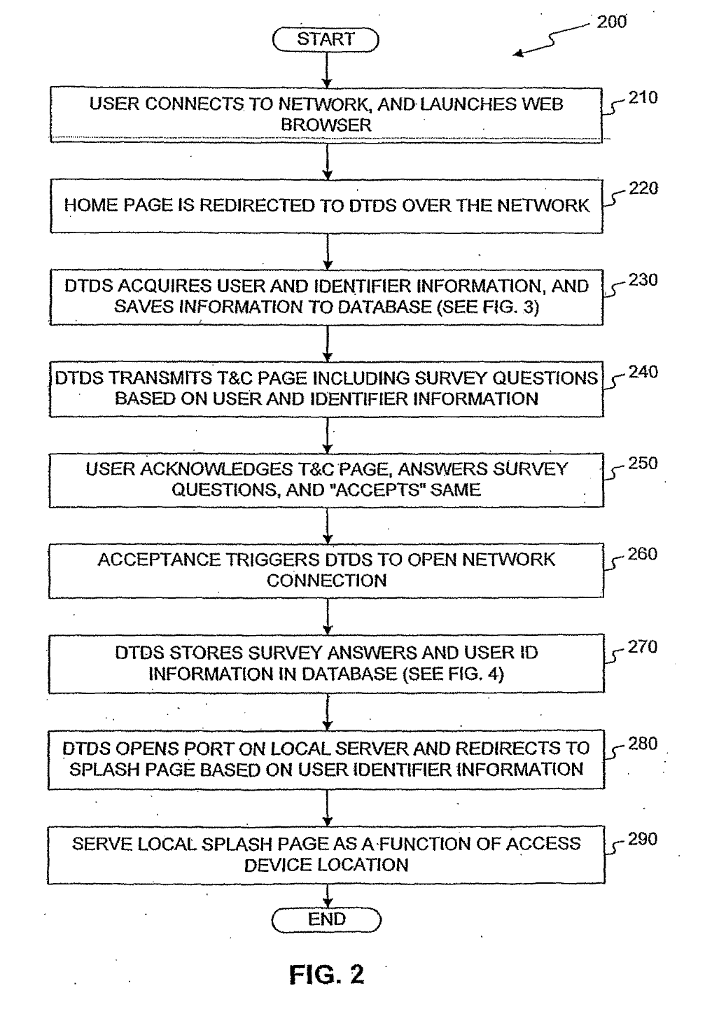

FIG. 1D illustrates one representative architecture for exemplary targeted-advertising business methods/models, according to one or more embodiments of the present invention. In FIG. 1D, a user with an ad-displaying device is coupled via any suitable means, such as a mobile Ethernet or wireless connection using 802.11a/b/g(n), to one or more Access Points (“AP”s) or wireless or wired access network devices (e.g. a DSL or Cable model or set-top box) coupled to a network. This Access Point network can, in turn, be coupled to a larger network, such as the internet, which is then also coupled to one or more platforms according to some embodiments of the present invention. As set forth herein, such platforms typically also have a database associated therewith. According to this embodiment, the larger network is also coupled to one or more service providers, which operate to disseminate content and services for entities such as business partners wishing to peddle goods or services. As shown in FIG. 1D, these business partners can be advertisers, each coupled to the one or more services providers. Embodiments according to this architecture overcome previous network interoperability drawbacks, for example, in that they avoid the need for any type of pay-to-use model, which have been shown to be unworkable. For example, in connection with the features shown, e.g., in FIGS. 2-10, etc., and their related written description, the platform of the present invention, in its role in redirecting user/internet traffic, accumulates increasingly valuable information for each MAC address and/or UID (Unique Identifier) [hereinafter “MAC/UID”] over time. Specifically, the knowledge contained in the platform database grows by however many new data points the system collects with each use. For example, in one preferred embodiment, the system collects two data points concerning that user, the MAC/UID at each terms & conditions page login. Collection of this data allows future advertising and auction models to base their delivery profiles from not just the content of their ad, but also more and more valuable/comprehensive data concerning the user. These information processing features afford highly personalized information delivery profiles, determined as a function of the location, context and user profiles set forth herein.

FIG. 1E illustrates another representative architecture for exemplary targeted-advertising business methods/models, according to one or more embodiments of the present invention. Except in special circumstances, the unique ID or MAC/UID is encrypted again to protect the information in the relevant databases, such as within the Engine Server 160. This is very important, as otherwise the whole encryption system may not possess adequate protection. The embodiment of FIG. 1E illustrates the interrelationships between some of the systems, sites, and entities associated with the targeted-advertising business methods and models disclosed herein. Specifically, FIG. 1E illustrates the basic architecture for information processing to and from these various system elements and entities.

Several examples of location- and destination-based services and information processing according to one or more embodiments of the present invention are next described. As set forth herein, embodiments of the present invention offer content services based on the location of the user. In scenarios wherein the location of a user is changing, such as due to their utilization of transportation means, the content services can be provided dynamically to incorporate the various different locations. For example, in embodiments where the user is located at a transportation location (e.g., an airport, train station, etc.), the network can assume that the user is planning to go to a particular destination. Knowing such locations, the system and network can determine the end destinations in a variety of manners. If the local means of transport is going to a certain select range of destinations, the problem and potential destinations are finite, and a small selection of destinations can be offered to the user. If the local means of transport could lead the user to any of a large number of locations, then the user can be prompted and/or manually enter the location. For example, as part of the ‘terms and conditions’ pages delivered to a user, as described herein (see, e.g., FIGS. 1L, 3, 7, etc., and their related written description), an option can be added to ask the user to enter the destination in question. Additionally, with the assumption that the user will arrive at their destination, the user's location can be pre-supposed prior to their arrival. The present network (based on current and projected location) can now deliver info about the current location (as before), the new location (as planned), or both (e.g., especially in cases where the user may want to compare the availability of a particular service in both locations before making a decision).

One specific example of such changed-location information processing is illustrated via the simple boarding of a train by the user at a train station. In this example, there might be, e.g., 15 known destinations where riders can exit the train. Furthermore, depending on other data collected and/or ascertained, the network can determine significant additional information concerning the means of transportation and related facets of travel. For example, depending on the time of day, the network can determine if the train is local or express. This would also allow the network to prompt or remind the user about geographic or temporal conditions of interest related to their travel. For example, the network could calculate the approximate time (or determine the actual time, based on closing proximity of end location) that the user should get off the train, and remind the user accordingly.

Moreover, the network can access local advertisers (e.g., restaurants within a few blocks of the train stations, local theaters in both destinations, etc.) to sponsor ads that are served at the specific network, e.g., a WiFi, WiMAX, DSL, Cable, IPTV etc hot stop at the train station, but that are aimed at the specific user. Based on the data provided by the present invention, these ads can then be keyed to where the users are going, what they could be doing that evening, etc. For example, once the network asks/determines at which city a user will arrive, the network can determine what type of events, advertisements, etc. are suitable for the user, such as those activities that coincide with the user's arrival time. With this network and database of information, the user can also more readily search and locate goods and services related to their present needs, such as local travel and events, food related to their destination and the like.

Another specific example of additional location-based advantages of the present invention is illustrated in the context of RFID (Radio Frequency Identification) and/or personal inventory and resources information processing, such as can be advantageously implemented in fields like emergency response. In emergency response, where any and all emergency responders in the theater can often play a critical if not life saving role, the knowledge of each responder's different equipment and skills is invaluable. Thus, there is a significant need to associate each such person, as well as their skills and equipment available at the time, with their location and aggregate capabilities. Coupled with the ability to identify the devices that the user is carrying at that precise moment (using RFID), systems and methods of the present invention can gather and target the information essential to saving lives. Specifically, the present invention can gather all of the location-centric and other relevant contextual information, as disclosed herein, key this information to the recipients of the emergency response, and then target the information by relaying and/or delivering appropriate orders and instructions to both the emergency responders and the recipients of their assistance. Regional and global scenarios can be orchestrated with multiple experts in widely dispersed locations, including a geographical, grid-computing approach for the overall command and control of information dissemination. For example, three different people can be directed to collaborate from different locations, e.g., to reach a particular piece of equipment desired.

In contrast to known systems and methods wherein identifier information such as MAC address are dropped at early router stages, some embodiments of the present invention, as shown, e.g., in FIG. 1F, implement identifier or unique identifier information throughout all phases of network processing and information delivery. By means of the technology of the present invention, identifier or unique identifier information such as MAC/UID is collected and transmitted to the Engine Server and associated database(s) for processing and re-transmission. The systems, servers, and software of the present invention, in the sense of their anonymous user embodiments, can also readily access, use, and process MAC/UIDs that are not in a clear format without negative impact on the value they add to the network actors who desire the key pieces of data. Thus, MAC/UIDs that are encrypted, encoded, corrupted, or otherwise not in their proscribed format are handled equally as dynamically by the present system. For example, a unique identifier consistent with the less-than-clear MAC/UID can be assigned, with all of the remaining data association and information processing steps remaining the same. Additionally, a key or basic data keyed to the unclear MAC/UID can also be generated and used. Moreover, the present system and software can encrypt the outgoing unique identifier information such that others privy to such data transmissions have no way of reverse engineering the MAC/UID from the communications and protocols of the present invention.

FIG. 1G illustrates additional exemplary information processing and delivery, according to one or more embodiments of the present invention. FIG. 1G illustrates how identifiers, unique identifiers including MAC/UID, and other location- or device-specific information, is handled by one exemplary implementation of the present invention. The MAC/UID, however, is not the only location identifier available and used in the present invention. The system of the present invention can obtain LAT/LONG (latitude and longitude information), or this data can be parsed to the present system by certain current wireless mesh network systems, which is then incorporated into location processing algorithms. Other devices or data points associated with a user, such as other wireless or WiFi, WiMAX, DSL, Cable, IPTV etc devices having an imprint on our network connection, can be assayed and their signal and location integrated into our location parsing (as well as all other information processing and delivery). Additionally, as shown in the upper left portion of FIG. 1G, the operating system (“OS”) and preferred language of the device and/or user can also readily be collected with or without the MAC/UID address. This information is collected by the mining software of the present invention prior to any type of acceptance or network entry by the user. In other words, it is picked up in a manner similar to that of the MAC/UID address.

FIG. 1H illustrates localized information storage and processing as previously known. In such systems, cached information concerning, e.g., users is simple kept in one or a few geographically-limited databases. This presents a significant problem when access and use of such information is needed immediately.

FIG. 1I illustrates some exemplary global information storage and transmission, according to one or more embodiments of the present invention. Here, systems and methods consistent with embodiments of the present invention cache the information and data associated with the device and the various associated profiles all over the world.

The unique identifier processing of the present invention is useful in a large variety of systems and software environments. While largely described in the context of hardware-implemented systems above, significant aspects of the present invention are also integrated into software applications such as implementation into browser and related cookie-emulating functionality. These applications are described in some additional detail in Appendix A (see, e.g., the fourth provisional application therein, Attorney docket no. 09783.6003-00000) and Appendix B. In such browser applications, when the built-in certificate mechanisms are used, the cookie-emulating functionality can also use certificates as a replacement for cookies.

Turning back to advertising-related embodiments, execution of advertising contracts could be implemented, in part, by using rule-based approaches coupled to a database system. FIGS. 1J and 1K illustrate some approaches to such advertising/business methodologies wherein, as detailed in the figures, the feedback and analytics of the platform act to enable an extremely efficient and directed advertising campaign. FIG. 1J shows a flow diagram illustrating embodiments of methods consistent with the present invention while also contrasting the methods with traditional advertising methods. As described in connection with FIGS. 1A and 1B, the Ad Engine uses information known or gathered regarding the current location, location related content, user location history, user browsing history, machine Address Code (“MAC”), other unique identification (“UID”) address-related information and/or information about the computing device coupled with other metrics to help the advertiser make decisions regarding content to be delivered. Moreover, in some embodiments, user interaction with a coupon or other interactive type advertising can be monitored to alter content based on user receptivity to certain offers (or the lack thereof). On the other hand, as shown in FIG. 1J traditional advertising methodologies depend on carpet bombing an end-user based on broad demographic assumptions about the visitors to a site and do not provide mechanisms for real-time interactive modifications of advertising content based on user feedback.

FIG. 1K illustrates one mode of operation for the targeted content-delivery system according to embodiments of the system. As shown in FIG. 1K, the presently-described network is associated with a publicly available WiFi, WiMAX, DSL, Cable, IPTV etc network. According to embodiments of the invention, when a user signs on to the WiFi, WiMAX, DSL, Cable, IPTV etc network, the event is detected by the AP server or by other elements of the inventive system. User-related information and local information are downloaded from the UN Engine Server, or from a network-cached image and this information is processed in order to deliver localized targeted content to the user using the transaction/trading manager.

This localized targeting can also be integrated with stock and inventory control systems located as any applicable business entity, such as retail locations. Such method would, for example, integrate localized targeting with real-time stock and inventory control systems to provide real-time localized and targeted advertising methods for wireless and wire-line access networks. (Although this embodiment is described here in connection with retail stores having real-time stock and inventory control, it is applicable with any consumer-driven regime wherein the business entity or retailer has knowledge of their inventory.) Even retail stores that have implemented extensive real-time stock and inventory control to optimize their operations encounter certain retail stock or stock-related problems. For example, there can often be fluctuation in the actual sales in a store, which means that fine-tuning of the cycle of advertising, selling and re-stocking of merchandise is left to a cycle of days or longer. However, if the advertiser is able to generate local advertising which is specifically triggered by an excess of inventory, and is targeted solely to those individuals within the cachement area of the particular retail location, then the complete process of advertising, selling and stock/inventory control is brought into tighter control. This provides real-time inventory control in a manner that might be described as an enhanced “blue-light special”, but where the ability to advertise is wider than inside a retail location and within reach based on the particular location and demographics of the retail store. The end result, as a business benefit, is the ability for the retailer to manage their stock and inventory better, and at the same time ensuring that they can serve their customers with goods, including the ability to promote items that are in excess inventory, by the use of promotions, coupons, rebates etc. Thus, integration of the localized targeting described herein allows for precisely this extremely tight control of retail cycle.

Embodiments of the system of FIG. 1A can also include a profile engine, which includes the ability to process MAC/UID (sometimes referred to as a MAC/UID profile or MAC/UID algorithm engine; see Appendix C of the priority application, the priority application being hereby incorporated by reference in its entirely). In one or more embodiments, the profile engine is a system with an algorithm designed to profile the MAC/UID based on the number of times and which location it joins a network (e.g., in a Free Internet Zone), coupled with survey questions and/or responses. This information can be correlated in the processor and given weighted incremental numbers that then are placed in profile buckets. When a user requests Internet access, the MAC/UID profile ID can be associated with the location tag, and the request associated with this information can be matched up with an appropriate sponsor for that location.

The survey questions and/or response can be obtain in any of a variety of manners. In one or more embodiments, this information can be collected by means of a user-input, interactive survey/preference button, as shown by way of example and not limitation in FIG. 1L. While several exemplary buttons are illustrated in FIG. 1L, many different colors, textures, audio clues, rollover features, etc., can be used given the basic framework shown here.

The current and conventional way to enter a network is to accept the terms and conditions of use by clicking on an “I Accept” button, which is a single action (e.g., selecting a unitary button on the interface) by the user to pass into the network. The embodiment of FIG. 1L transforms that simple action into a survey/preference action, over and above the mere acceptance of the terms of using the network. Thus, rather than using conventional survey formats (i.e., scale of 1 to 5, or clicking on one of several options (like an SAT test), embodiments of this concept use a simple “one-button” regarding which the user is invited to offer a preference or answer a simple question. The result of making the selection is both to enter the network and to send information to the survey source in the network. One result of the action of the click is to accept the terms and conditions, and is managed by the access permission server in the network. The other result of the action of the click is to respond to the survey, and this information is stored in the user's profile, and also used to amass statistical data for users entering or re-entering the network.

The user profile is therefore enhanced with the survey information for that individual user, to be used in targeting the appropriate content in future sessions, using e.g., an inference engine, to deliver appropriate content based on the preferences shown by the user. The collated data from a survey is used to attract specific advertisers to improve their targeting and demographic tools. The user profile from one survey is combined with prior user survey data to continually enhance the demographic data of the user, and thereby improve the ability to target the requirements and specific content/context of the user's needs.

In subsequent surveys, embodiments of such survey functionality (after the user has looked at more than three surveys, for example), can also provide an option which allows the user to “reset” previous survey data, which is a very powerful tool. Thus, if the user wants to “clear the record” and try a new set of preferences and experiences, the user has the ability to do so. This feature may be offered every time to a user, or after a certain number of surveys. This feature may also be offered in view of other special circumstances, such as when a new class of survey is developed, where best info is gathered from a clean-start approach rather than stale/accumulated data. The survey engine, in one or more embodiments, can also ensure that the very same survey is never served to the same user more than once, to ensure that the information is never repeated.

The inventory of the surveys to be conducted can also be made dynamic, and sponsored by many different entities, and served according to location and context, in the same way as relevant and useful content is also served locally by using the profiling engine. In cases such as this, the survey is targeted to the time, place, location, etc., and not necessarily to one particular user. Such functionality can be used, for example, to capture the “mood” of the collected community at that particular location. The survey can also be done across similar demographics across multiple locations (e.g. on a particular day, we can survey preferences of a Hispanic population about the potential winner of an Argentina/Brazil Soccer match, or the popularity of a music or movie star, etc).

Another advantage of this MAC/UID profile engine, according to some embodiments, is that it can offer a unique relevant target for localized information/advertising or specific service to each user from the same network. A further advantage of implementing a MAC/UID profile engine, according to one or embodiments of the present invention, is collecting network usage, which, in turn, allows the system to most efficiently deploy access points. An additional advantage in one or more embodiments allows for the determination of where it needs to move its access point for better utilization which helps reinforce the Internet access methodologies/economies set forth herein. Yet a further advantage is the ability to determine trend rates per zone, which is of value to advertisers in the local region. The MAC/UID engine registers the MAC/UID address in a database table along with the times of use, the AP location, and the MAC/UID profile.

In some embodiments the Engine Server includes central authorization software that enables the system to inter-operate with hybrid public Internet access networks by receiving and tailoring content for the end user but without managing various remote hardware, such as a remote routers or access points. By managing the AP server or XML gateway (as opposed to the routers at remote location) this remotely managed, point of entry, networked, and targeted content-delivery system can co-exist with existing deployed networks with very few barriers. For example, even where an existing network has bandwidth limitations, such as for example, a business with a one megabyte/second data pipe up and down may still want to benefit by allowing a free internet zone to customers in its place of business. In such situations, the system may be configured so that the amount of network bandwidth not used by the business may be apportioned to users, for example, by limiting the public zone to 256 kbps up and 700 kbps down, and by limiting each user to no more than 128 kbps up and 500 kbps down. In some embodiments, the Engine Server site profile can be updated centrally to provide appropriate bandwidth when the request comes from a user, or to adjust the bandwidth based on time of day and consequent expected usage. In some embodiments, the bandwidth policy can be based on committed information rates, or respond to certain predetermined agreements based on business relationships (e.g. all users who are employees of a particular company will receive a committed information rate for their access to the network; or during times of civil disruption such as a natural emergency, the bandwidth can be tailored to ensure that emergency response users have preferred access, priority and bandwidth allocation, over that of normal commercial users.)

These WiFi, WiMAX, DSL, Cable, IPTV etc /UN Engine Server embodiments collect and provide pertinent information about a subscriber. This information can be, for example, information of value to commercial entities, and it can also be limited in its scope depending on the existing practices, legal, and/or other considerations.

In some embodiments, the transaction/trading manager may be capable of supplying effective content-delivery efficiently to end users, and of generating revenues based on the effectiveness of the content-delivery, and from actions resulting from the delivery of content. In some embodiments, the transaction/trading manager's functionality may be used for a dynamic real-time locale-related advertising trading system. Thus, the present invention provides an advertising technology and scale that is unprecedented, as it is targeted, personal, interactive, and location-dependent. Further implementation of the platforms, systems and methods of the present invention are set forth in Appendix C, which is incorporated herein in its entirety and attached to this application.

In some embodiments, specialized changes can be made to the AP both before shipment and on location. The changes to the AP solution-in-a-box or AP server 120 before shipment can include: (1) firmware installation, upload, updates, upgrades; (2) optionally, software code on top of the firmware; and (3) inventive configurations, embodied in configuration files for above firmware and software. According to embodiments of the invention, inventive configurations could include: (i) a unique identifier (serial number, or name, or other); and (ii) an IP address at the network management system to which the AP server will “report” after power-up.

In some embodiments, changes to the AP server 120 on location can include: (1) the automatic provisioning procedure on power-up to add the AP solution-in-a-box or AP server 120 to the network management system, including (i) requiring the AP server to contact to an IP address at the network management system for registration or “sign up,” (ii) transmission, by the AP server, of its unique identifier, and (iii) entry of the new AP server into a system/network/server database; and (2) changes and provisions relating to the location-specific setup of the box, including: (i) transmission of information and data from the UN Engine Server 160 to AP server 120, (ii) provision of service configuration, including new and/or updated service configuration, (iii) terms and condition pages for distribution to users, (iv) firewall and other security settings, updates, and configurations, (v) port specific setups, and (vi) authentication/authorization settings, among others, as set forth below.

Thus, embodiments of the invention may include a process and product by which the access point (AP) targeted delivery solution may be shipped to a location where there is available:
A commercial broadband connection typically Ethernet, but which could include DSL, Cable Modem, T-1, E-1 or fiber.
Local power to power the equipment
A suitable location (typically with considerable latitude regarding mounting logistics, but where either written or software directions would be provided to ensure that the antenna is properly located).

Among other advantages, some embodiments described herein also allow subscribers to: (1) lower the complexity of deployment of adding a location to the UN network, (2) increase ease-of-installation so that non-technical persons can install the access point, (3) speed up the time to bring a location (access point) online, and (4) increase desirability and/or acceptance vis-à-vis the decision makers (vendors, such as retailers, cafes, etc.). Thus, embodiments of the present invention allow the location owner (such as commercial retail enterprise, e.g. clothes store, restaurant, hardware store, etc.) to receive the AP solution via expedited shipment, and have the network up and running within minutes. The plug-and-play set up allows a network provider to distribute AP targeted delivery solution boxes at a rate, for example, of hundreds per day, in contrast to having to train and send out personnel to such locations, which would incur a cost of many hours per access point location. This model also scales to reach locations anywhere in the world, since the AP Servers 120 can be shipped to any location in the world, with the appropriate infrastructure described above.

According to embodiments of the present invention the AP server may be pre-configured via software with the location and key identification data before shipping to the location owner. Such pre-configuration allows the box to be instantly discovered by the system as soon as it is plugged into any broadband Internet connection. At this point, the box may be administered over the Internet. In addition, firmware and software upgrades may also be uploaded to the box. Examples of the information that can be loaded are: location, unique identification, channel and power configurations, and other information described in more detail below. In some embodiments, the loaded information can be subsequently used in a larger platform context. In some embodiments the MAC/UID of devices using AP server 120 provides the raw material for measuring usage behavior on AP servers on the network. Since traffic can be remotely monitored, if the load on the network is excessive at a location, an additional AP server can be shipped to that location, so that both virtual and physical aspects of the network can be managed.

Some exemplary embodiments of deployment approaches and business methods follow. First, in some embodiments, public access can be made available adjacent to a business such as a retail location. In some embodiments of a method for targeted content delivery, a business may install one or more of the boxes on their premises to support both the internal operations of the business (e.g. laptops for the stocking staff in the building) and to provide internet access to customers, or others with mobile devices, wherein the public access network would be used for targeted content delivery. Second, in some embodiments, where there is no physical access to a business by an advertiser or content provider (e.g. the business is in a difficult to reach location), the platform/UN Engine set forth herein in conjunction with the present system can manage the AP server network and operations remotely. In some methods for deployment, a business relationship may be created with an existing public WiFi, WiMAX, DSL, Cable, IPTV etc network provider in a city where, in exchange for the provision of WiFi, WiMAX, DSL, Cable, IPTV etc services, targeted advertising or other commercial content is directed to end users.

The access point targeted content delivery solution can be deployed into the present systems and methods in a wide variety of ways. In some embodiments, the AP Server 120 is connected with the UN Engine Server 160; however, the implementation of other elements of the system can vary. FIG. 1M illustrates two possible system embodiments by which an AP may be integrated into the UN platform, a stand-alone implementation (Scenario “1,” as labeled in the figure), and as part of a system having the solution-in-a-box (Scenario “2”).

According to some embodiments, Scenario 1 can be a multi AP or “Bolt-on” solution for an existing network. According to embodiments in Scenario 1, an existing network, for example, could be transformed to a location-enabled system of the present invention through the insertion of an XML gateway at the broadband origin. FIG. 1N illustrates how an XML gateway may be integrated into the inventive platform. In some embodiments, the XML gateway may be upgraded with the appropriate software or firmware, in order to be integrated in to the platform. In some embodiments, a pre-configured gateway could be supplied to perform the requisite location-centric inventive network transformation. Following the integration of the XML gateway, multiple “dumb,” generic inexpensive AP's could be deployed. In some embodiments, a properly configured XML gateway may perform some of the same information routing and processing functions as AP server 120. Scenario 2 can be any stand-alone installation where only one box is required, such as in businesses (cafes, retail establishments, restaurants, etc.). Exemplary products, tools or languages that may used to deploy the system include: (i) standard off the shelf server class computers, MS IIS web servers, databases including a MS SQL Servers, using SQL, and any of a combination of XML, SOAP, ASP, or HTTP languages; (ii) network operations, monitoring and scheduling equipment; (iii) remote location equipment; (iv) wireless or wireline transmission and access hardware and software systems, such as may be provided by do we need these names in a patent?; (v) signal amplifiers; (vi) external antennas; and (vii) one or more signal splitters. The components set forth above are only exemplary and equivalents may easily be substituted to achieve substantially the same functionality. Systems and methods of the present invention can be implemented on a variety of networks, both wireless networks such as WiFi, WiMAX, DSL, Cable, IPTV etc and via wired technology, as well as via any other known or emerging network technologies.

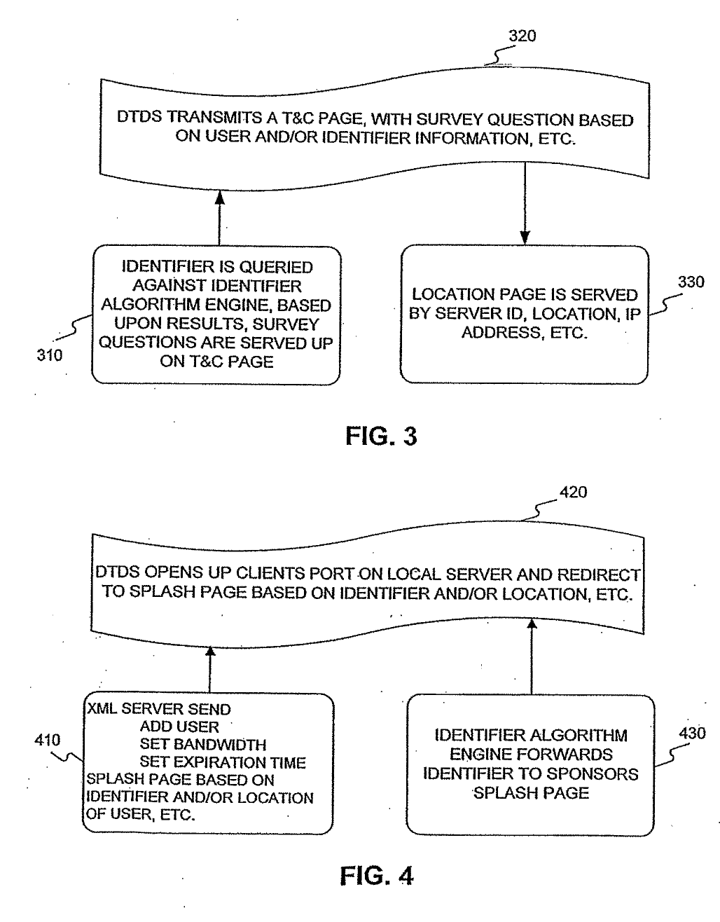

FIG. 2 depicts an exemplary flowchart with steps 200 consistent with one or more embodiments of the present invention. Referring to FIG. 2, a method of collecting and processing information consistent with certain aspects related to the present invention is illustrated. As shown in FIG. 2, an end-user first connects to a public network and launches a web browser (step 210). The browser is not allowed to access the default home page of the computing device, but rather is redirected to the Engine Server 160 (see FIG. 1A) (also referred to as the “Device and Targeting Database Server” or “DTD Server” throughout) over the network (step 220). Beginning with this very first handshake/data exchange whether through hypertext markup, radius accounting records, or back-channel communication (example—simple header insertion of Feeva Tags into the session in progress), the DTD Server 160 acquires user profile and selective anonymous user identifier information, and begins saving this information to a database, this information can be new or simply building upon an existing profile (step 230). The profile protects user anonymity by using the UID as a proxy for the individual/Device. The information stored in the database may be, inter alia, time/date information, initial home and/or default page information, location information such as that derived from the server or access point IP address or ID, specific identifier information for the user (e.g., MAC address, etc.), additional information can be provided by third parties who wish to exchange existing user/device information and/or store this third party information indexed by the UID for future transactional reference, as well as any other information acquired by the DTD Server 160 at this time. As a result of survey (or single question answers) and profile engine processing (as detailed in connection with FIG. 3, below, and elsewhere), survey questions specific to each user are generated based upon the acquired information. DTD Server 160 then transmits first data such as a terms and conditions (T&C) page with these survey questions to the user (step 240). The user may then answer the survey questions and acknowledge the terms and conditions, for example, by selecting an “accept” button (step 250). In response to receipt of this acceptance, the DTD Server 160 can open or instruct the network equipment to open a network connection for the user (step 260). The DTD Server 160 also then stores the survey answers as well as any new or related user identifier information in a database (step 270). Additional processing related to this new (e.g., survey) information is performed by the DTD Server 160, as set forth in connection with FIG. 4. As a function of this additional processing, the DTD Server 160 opens up (or instructs network hardware to open) a client port on the local server and redirects the user to a splash page (also known as landing page) determined as a function of user identifier information with components customized for that individual (step 280). Suitable splash pages may be retrieved and stored in network cache. Finally, a local splash page, determined as a function of the access device location, is sent to the user's browser (step 290). Furthermore, all of the content transmitted to the user (e.g., first data, splash pages, etc.) may be formatted and/or indexed to the specific type of access device utilized by the user, as determined by the DTD Server 160. The cumulative profile generated by DTD can be accessed for future use during that session or sessions that follow. The profile information tag (UID) will be transmitted to every destination (website) that is accessed with this device thus enabling the customization of end-user content specific to UID (universal identifier).

FIG. 3 shows an exemplary technique regarding how information including survey questions may be generated, transmitted, and processed, according to one or more embodiments of the invention. First, the identifier is queried against an identifier algorithm engine 310 to determine if a profile exists for that user and, if so, which survey questions the user has already answered. Based on location, stored user profile information, and user responses, the DTD Server may decide to serve additional, unanswered survey questions. As a function of these determinations, any outstanding survey questions are associated with the terms and conditions (T&C) page. The DTDS 160 then transmits the T&C page with the survey questions 320. A location page may also be served as a function of server ID, location, IP address, etc. 330. In some embodiments, the information received typically enables the Profile Engine to serve up targeted advertisements (e.g., banner ads, rich media, video, audio, and other content keyed to user information such as location, user profile information, etc.), sponsor logos, and pages such as first pages, splash pages, etc.

FIG. 4 shows another exemplary technique regarding how information may be collected and processed when an XML gateway or Radius based implementation is used, according to one or more embodiments of the invention. As shown in FIG. 4, an XML Serving component of the DTD server may forward information such as identifier information (e.g., the MAC address and/or UID of the access device), the bandwidth allowed to the user, and a session expiration time to the DTD Server 410. The DTD Server then opens up a port on the local server and redirects the browser to a splash page based on identifier and location information 420. The DTD Server may also retrieve user identifier information and downloads a splash page and local advertising information based on the associated user profile 430. DTD Server 160 may also access port numbers of the XML component to implement separate channels for acquiring or providing data to/from end users, advertisers, and content providers via this “back-door” technique. Radius server component could also accomplish similar data acquisition or provision based on Radius records that exist in a Radius-based environment, such as log-in files and history. However, in some embodiments of the present invention, intra-cell blocking to prevent client-to-client snooping is accomplished using without-radius technology.

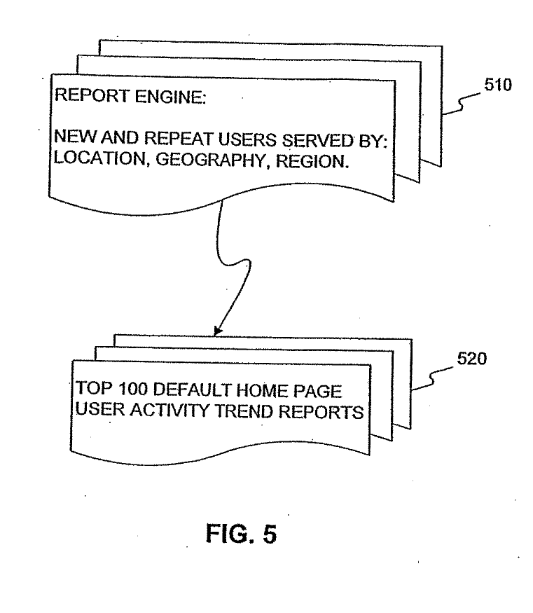

FIG. 5 illustrates other data gathering and reporting functions performed by one or more embodiments of the present invention. In some embodiments, aggregate information may be collected by a report engine, such as the number of new and repeat users at a given location 510. The report engine may parse these new and repeat user statistics according to location, geography, region, and other characteristics of user service. In some embodiments, a list of user-activity trend reports may be generated such as, for example, the top 100 default home pages used by users 520. Such trend information could be used to target potential web sites or advertisers to generated revenue for the DTD-associated network and targeted content delivery service. A simple profile can be created without knowing any personal information of an end user, but enough information may complied by eventually to offer relevant content based on the current location and time of day the user has accessed the network. In some embodiments, Pool IDs (PIDs) are created and a user profile may be associated with multiple Pools. A Pool is a high-level survey-based grouping that may be inferred based on survey results. Sub Pool IDs may also be used to provide a hierarchical relationships for sub-groups within these Pools. Other Pool-related data that may gathered and/or stored include, a Historical Profile Pool ID, which may include the evolution history of an identifier profile (e.g., a MAC profile), a Historical Location ID & Usage Counter, Historical Survey ID & Response, Survey Results Per Location, and all other combinations of Pool-related data with any user or profile related data maintained by any of the processing components.

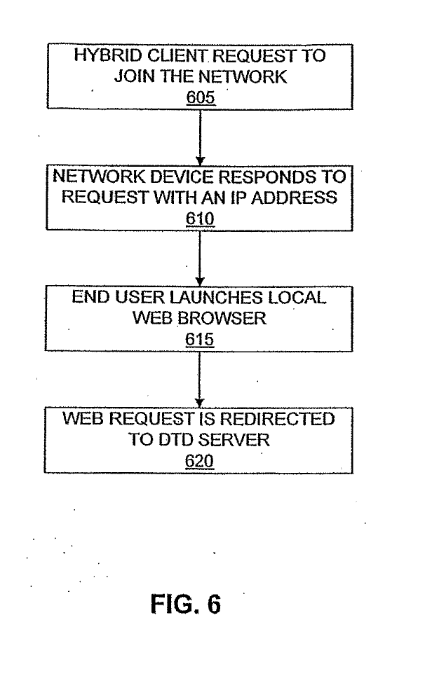

FIGS. 6-10 are flow diagrams illustrating some functionality of one or more embodiments of the present invention. Each step of embodiments of the algorithms shown in FIGS. 6-10 is demarked with a numerical identifier, 605 through 1010. The description of each step, in association with its numerical identifier, is set forth below.

In step 605, as shown in FIG. 6, a user connects to a hybrid network via any known mechanism, such as by a Wireless or an Ethernet connection. The access device (for example a PC, PDA, or Wi-Fi Phone) requests an IP address from a Routing/Connectivity or network device such as a local Dynamic Host Configuration Protocol (“DHCP”) server.

In step 610, the RCD or network device assigns an IP address to the access device. An access device identifier, such as the MAC address, is then registered in the RCD or network device and is placed in a pending status. When this identifier (i.e., MAC address, in the present example) is first seen on the network or a user registers to the system, the DTD Server instantly creates a profile ID and database record based upon this identifier information.

In step 615, the end user now launches a local web browser which makes its initial request to go to the user default home page.

In step 620, the RCD or network device intercepts the request and redirects the request to the DTD Server on the network, while also transmitting the identifier (e.g., here, MAC address), local IP address, and original home page URL, along with the network device IP address and other specific identifier information.

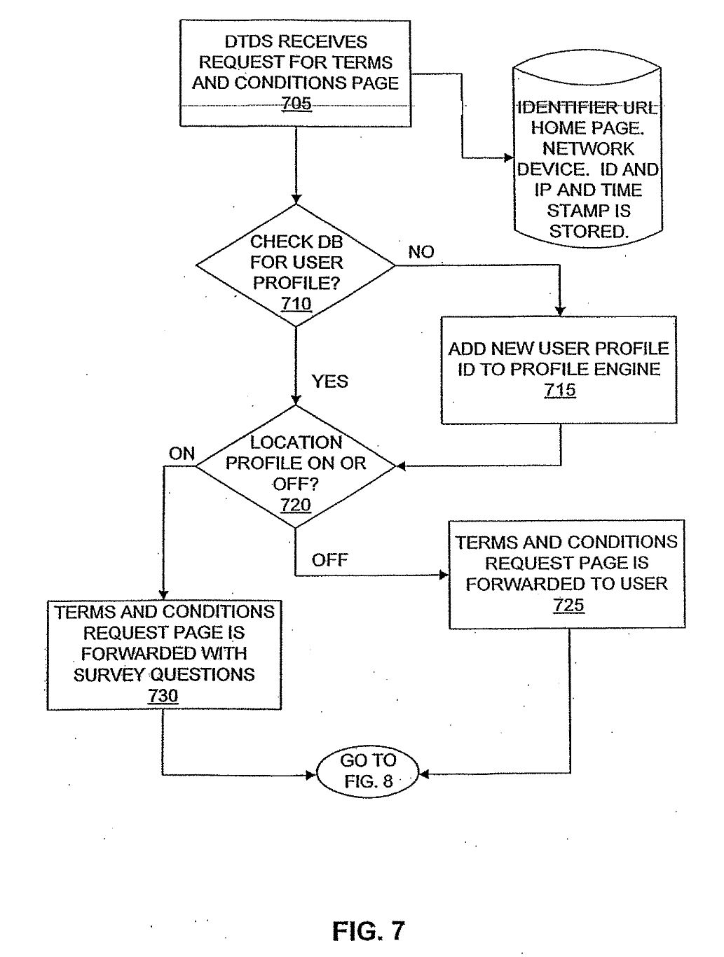

In step 705 as shown in FIG. 7, the DTD Server 160 receives a request for the local Terms & Condition (T&C) Page from the end user. During these initial exchanges, the following exemplary information may be acquired by the DTD Server and recorded in the Profile Engine: identifier information such as end user MAC Address, Local IP Address, Default Home Page URL, RCD and/or Network Device ID, Network IP Address (e.g., for RCD, Network Device, etc.), Location ID, Local Language on Computer, Operating System/Device Specific Information, Nest Requested Home Page, Survey Results, Date and Time Information, as well as other information derived from the access device, the user's behavior, or information concerning the user generated at or by the RCD.

In step 710, the DTD Server checks against the DB to see if the identifier acquired has an existing profile (profile ID) associated with it. In step 715, if there is no profile ID, then the identifier is added to the profile Engine and assigned a Profile ID.

In step 720, the location ID is checked against the location profile database to see if the profile tag is set to on or off. The profile tag is set to “off” if the identified user has an existing profile and answers to all of the survey questions are on file. If the profile engine is in need of the answers to outstanding survey questions, the profile tag is set to “on.”

In step 725, if the profile tag is set to off, then a Local T & C page is forwarded to the requesting end user's browser.

In step 730, if the profile tag is set to on, the location T & C Page is matched up with the user profile ID as well as the required survey question(s), which are forwarded to the end user browser by instruction from the DTD Server. The end user would never see the same survey question asked across any location on the network, since DTD Server tracks the identifier throughout the network.

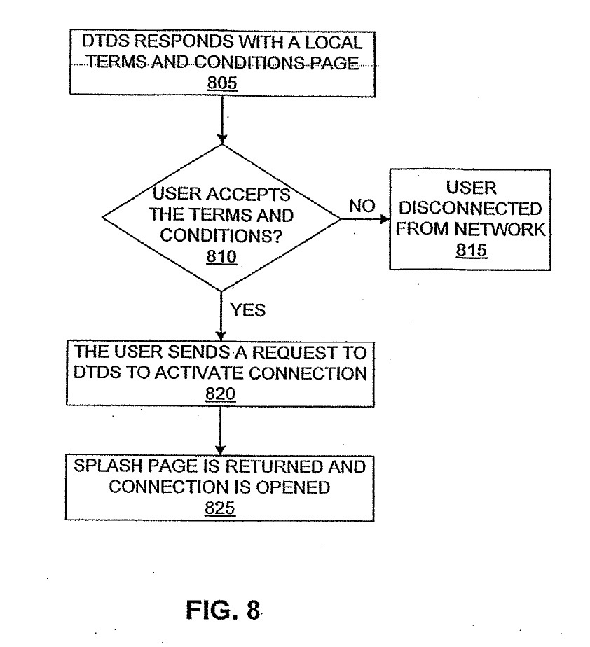

In step 805, as shown in FIG. 8, first data such as a welcome page with Terms & Conditions (T & C) is transmitted to the end user. This return page is already formatted to the device type, screen size, and format, which is/are specifically tuned to the device's capabilities.

In step 810, the end user is asked to accept or decline the T & C page condition. If a survey question is also provided here, the user has to answer the question in order to move forward.

In step 815, if the user clicks on the disagree button (regarding the T&C's), the user browser is redirected to a courtesy page requesting him or her to disconnect from the network. Alternately, a processing component may respond to a disagree selection by providing a less then full-service web experience. For example, a DTD Server may restrict the user's time or bandwidth on the network, or offer reduced guarantees of priority, traffic, and/or other performance characteristics as compared to those provided via acceptance of the terms and conditions. In some cases, these restrictions may be implemented by permitting basic web-browsing while blocking Virtual Private Networks, thus preventing a user, such as a corporate user, from accessing e-mail or using other important features associated with such networks. Restrictions may also be implemented by introducing jitter and/or delay to the extent that VoIP performance and real-time streaming of video services are not feasible or satisfactory, though browsing the web is still possible.

In step 820, if the user clicks on the Accept button, another request is sent to the DTD Server to activate a user's pending status to active status so they can now use the Internet freely. This is the unrestricted mode of using the access network, which allows the user to utilize all of the features and functionality of the Internet. However, access can still also be moderated by a pre-determined and/or real-time access control system. Such moderation or control may enable determination of the actual bandwidth and other performance characteristics contemplated. For instance, if certain identifiers have been pre-programmed within the network to restrict VPN access, then any policies of specific user access can be implemented at this stage. Next, in step 825, a splash page is transmitted to the user and a connection is opened.

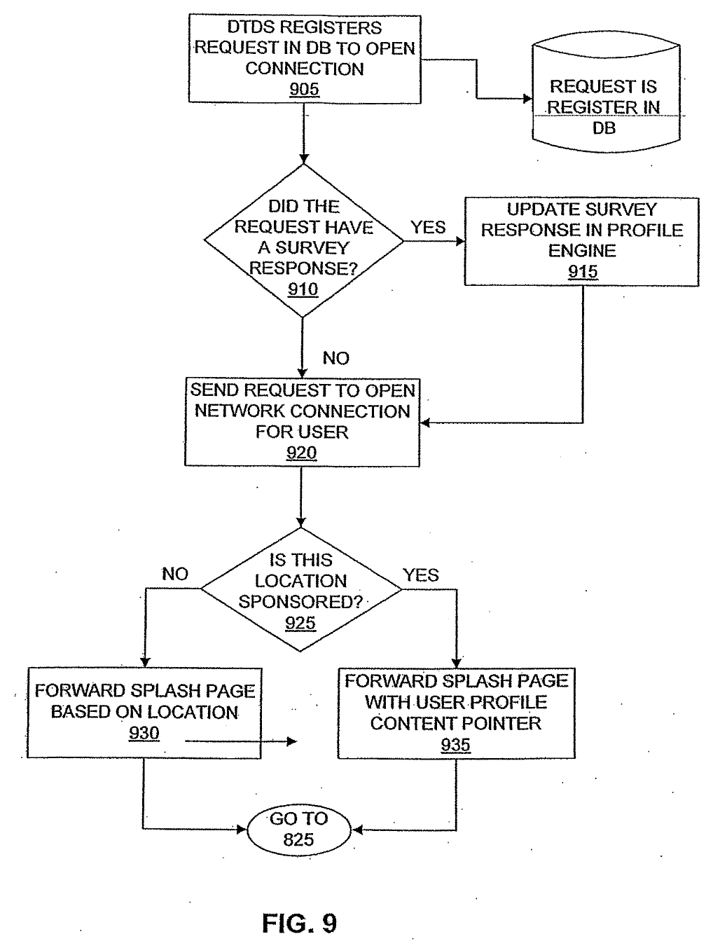

In step 905, as shown in FIG. 9, DTD Server registers the request and time of the request in an associated database. In step 910, if the request includes responses to survey answers, then they are forwarded to the Profile Engine. In step 915, survey answers are updated against data already stored for that user in the Profile Engine.

In step 920, the DTD Server now transmits some commands to the network device to activate the pending status, set the upload and download bandwidth speed per the identifier, and set an expiration time of when the user's session will expire for that network.

In step 925, the user's Location ID is checked to see if it has a sponsor associated with that location. In step 930, if there is no sponsor a generic local splash page will be sent to the requesting user. In step 935, if a sponsor is associated with that location ID based on the location profile database, a splash page with relevant local information, and a targeted advertisement based on the users profile ID will be sent to the user.

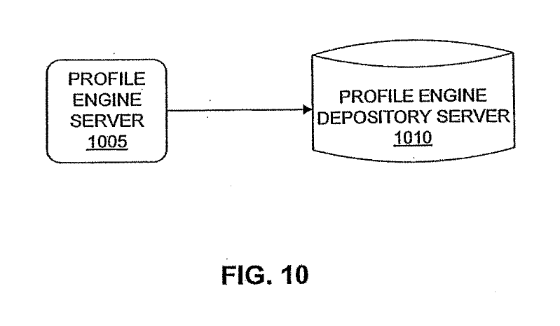

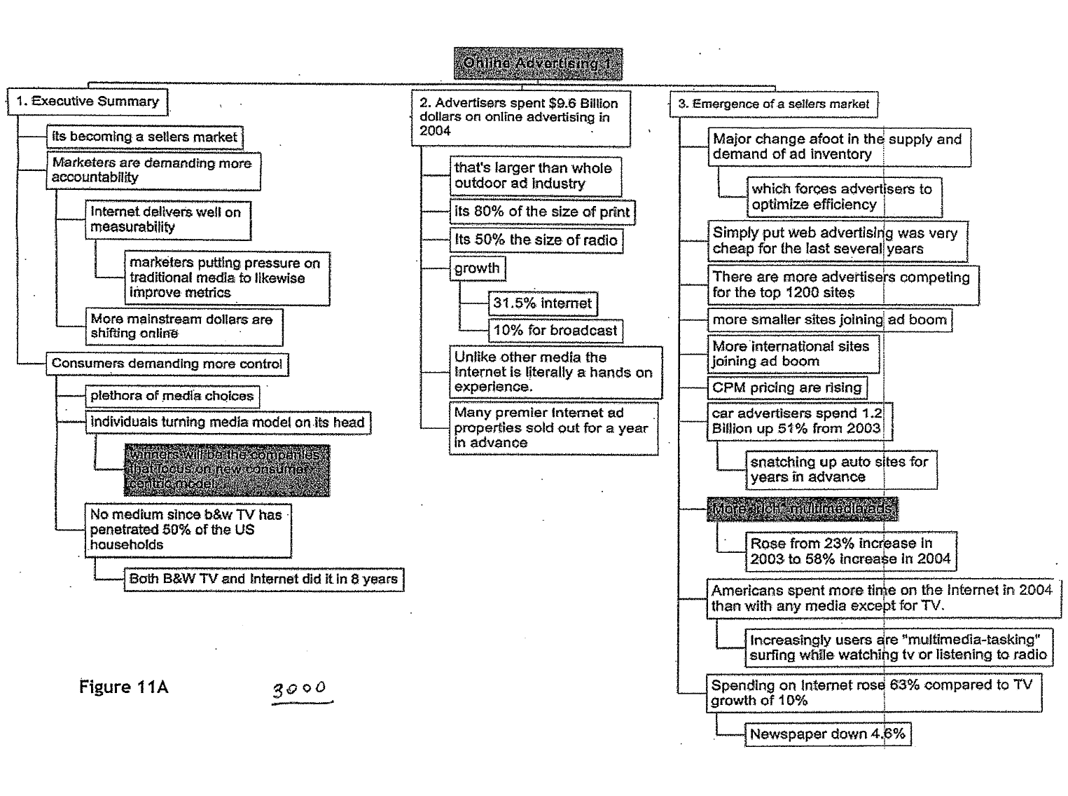

In step 1005, as shown in FIG. 10, the profile engine server performs the Profile Engine algorithms on the data. The Profile Engine algorithms are based on a scaling value counter system, where value is given to every interaction of the identifier or MAC address and/or UID (for example, a MAC address and/or UID may be profiled on the number of times it has used the network, or it may be profiled by answered survey questions). As the Profile engine builds a profile using an identifier, it also places the information in associated bit buckets. Requests are then paired up with lose associated bit buckets and then mapped to sponsor advertisements profile(s). Finally, association of each sponsor is made to each location. The results are then stored in the Profile Engine Depository Server, step 1010.

The Engine includes an analytics components to carry out the various data processing operations, such as collection/distribution of information and profiling. In some embodiments, a method of collecting/assimilating data and distributing relevant information to users is disclosed, comprising: (a) implementing a system comprising a business partner, (b) obtaining RAW DATA, including MAC/UID and location information [and, optionally, survey information], such as: End User MAC/UID, Local IP Address, Default Home Page URL, Network Device ID, Network IP Address, Location ID, Local Language on Computer, Operating System/Device Specific Information, Nest Requested Home Page, Survey Results, Date and Time Information, as well as other information derived from the computing device, the user's behavior, or information concerning either, generated at or by the Access Point; (c) creating a profile based on each MAC/UID, formulated from location, time of day and frequency; (d) creating a profile ID associated with each of the one or more MAC/UIDs; (e) creating profile groups; (f) associating the MAC/UIDs with profile groups; and (g) comparing the profile groups with the desired audience of the business partner's data/information/product; wherein, based on the results of the analysis, associating the target information provided by the business partner and delivering to the user with the response via the network or system.

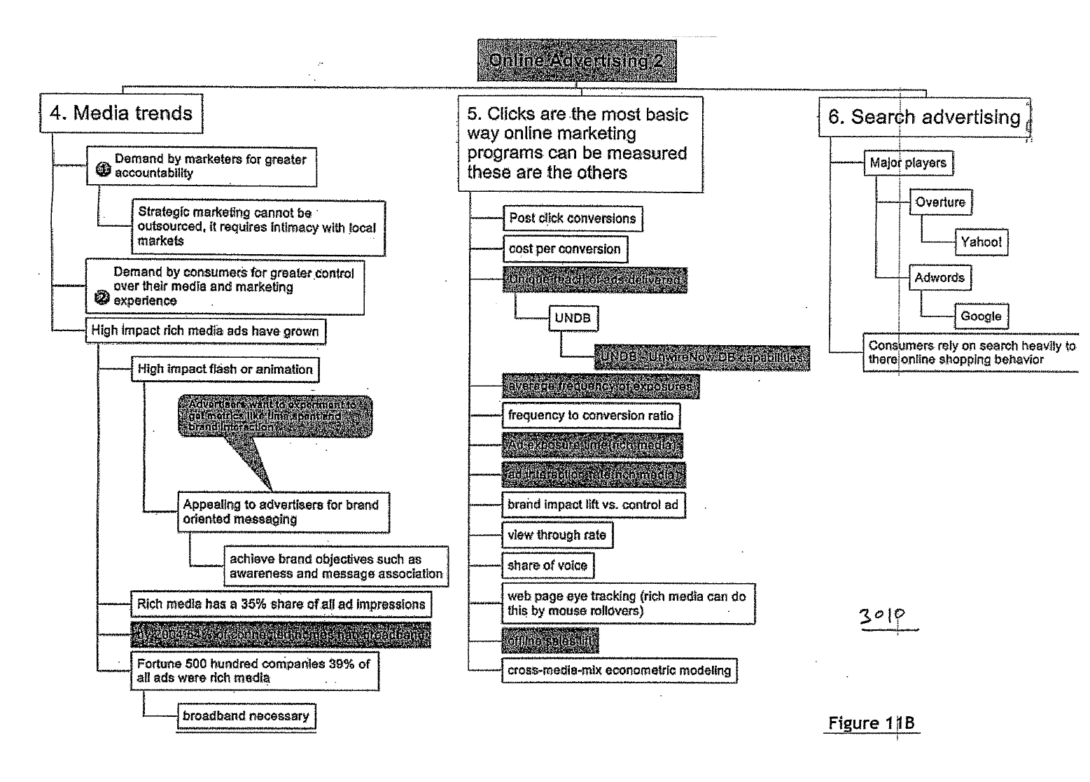

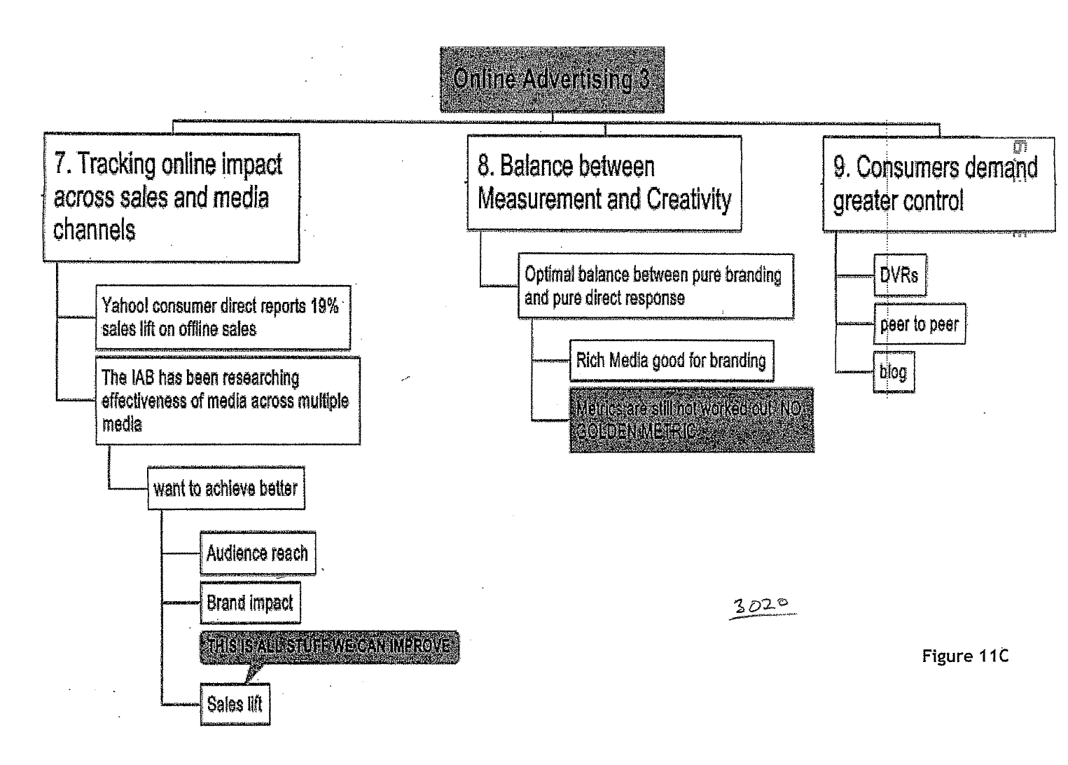

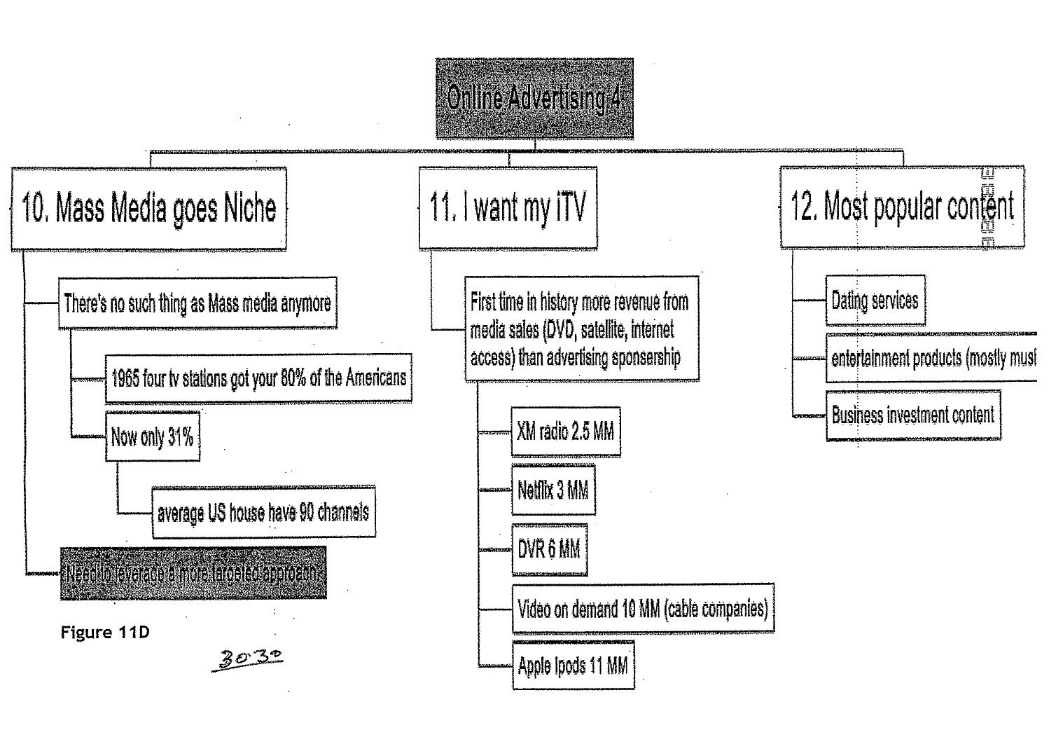

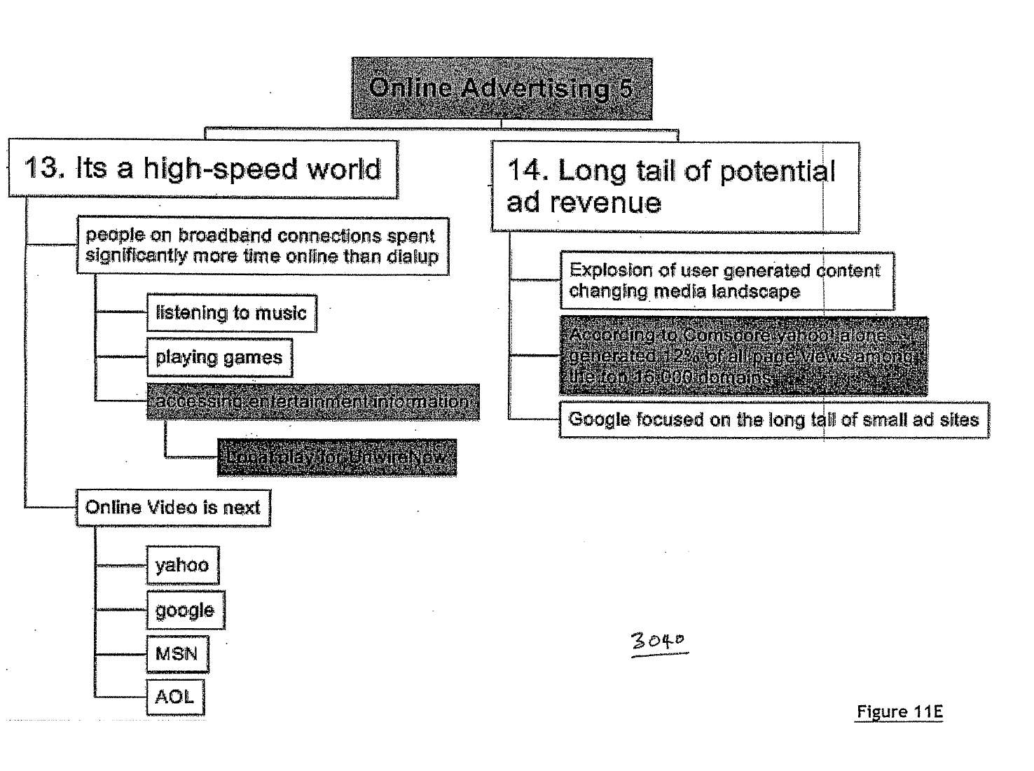

FIG. 11 is a chart illustrating various business method/model considerations relating to online advertising implementations, according to some embodiments of the present invention. The chart details the slow adoption of multi-media content by advertisers relative to consumers, identifies issues related to targeting consumers, and advertiser-related considerations that web-sites should take into account when devising advertising-based revenue models for a web-site or group of sites. The chart notes that content-rich media has a greater probability of attracting end-user attention. However, content-rich multi-media content demands bandwidth that is not practicable in the current carpet-bombing advertising methodologies practiced by web sites.

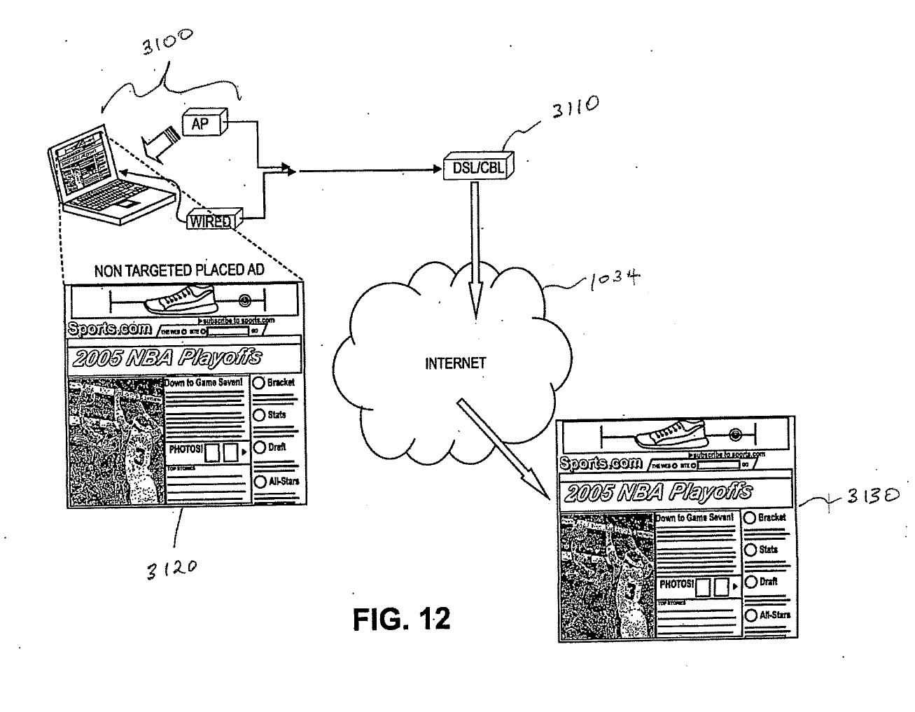

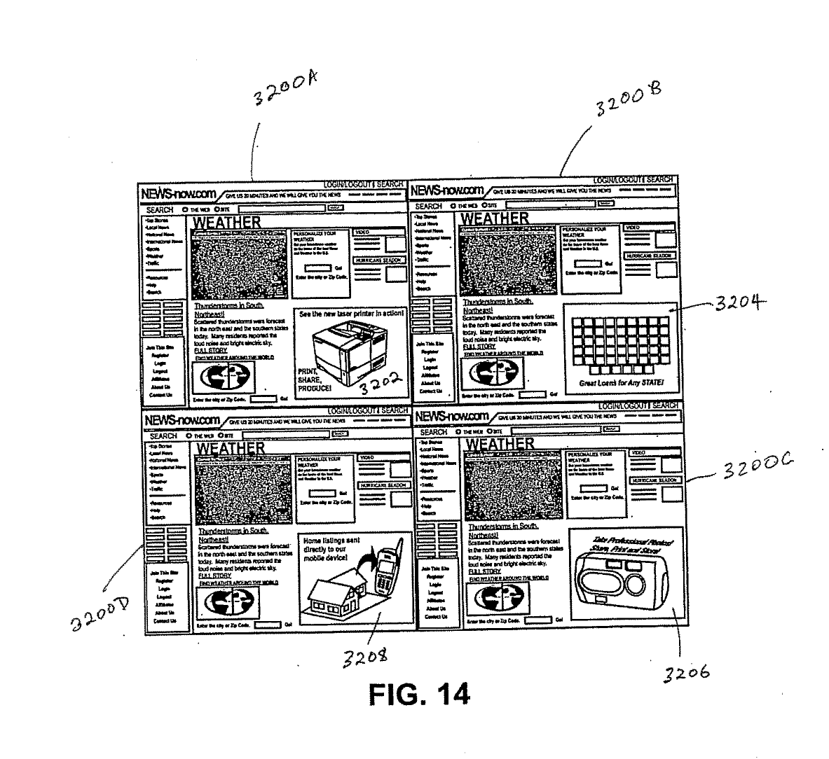

FIG. 12 illustrates traditional web-based advertising methodology. As shown in FIG. 12, a web-site chooses from a limited inventory of advertisements, as shown in FIG. 14, and picks an advertisement for display on a user's browser based on rough demographic or cookie-based information that may be provided to the ad-server.

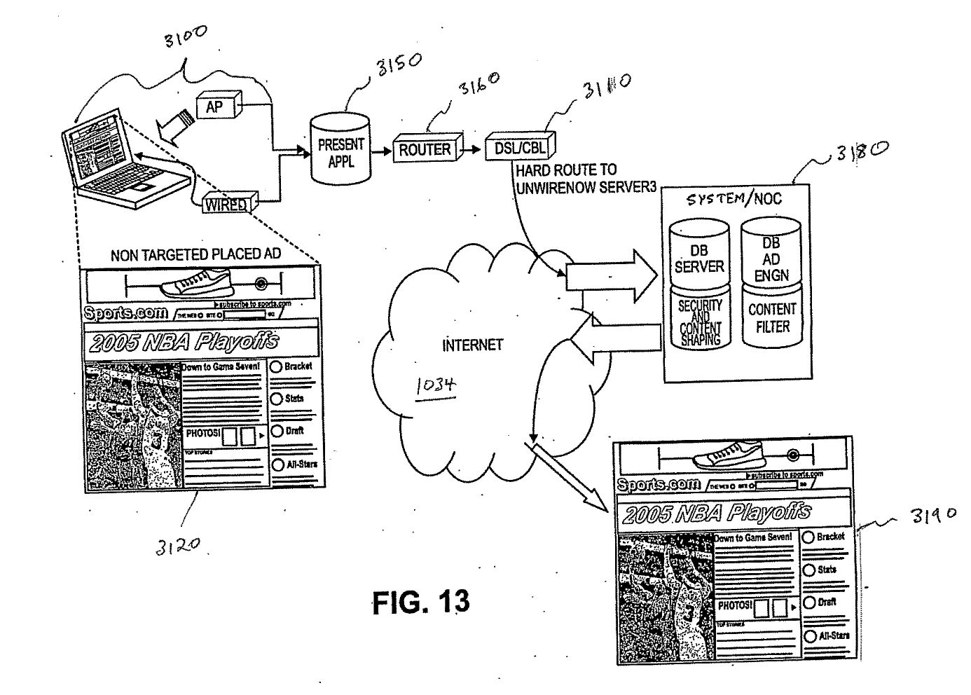

FIG. 13 illustrates a targeted advertising methodology according to embodiments of the present invention. As shown in FIG. 13, the ad-server now has information provided by the Network Operations Center (NOC). At the NOC, an Engine Server may read a database to get profile information, as well as analyze information regarding location-centric information provided by an AP server. This information may be packaged and provided to the ad-server, which uses the packaged information to pick an advertisement targeted at the end-user based on the analyzed profile and location information. The targeted advertisement is then served to the end-user as shown in FIG. 12 under the heading “LOCAL TARGETED AD.”

FIG. 14 illustrates current advertising inventory at a site using traditional web-based advertising methodologies. On account of the fact that every user must be served multiple advertisements, bandwidth, time spent by the user at the site and other considerations dictate that only a few advertisements form the ad-inventory of a web site. These advertisements are placed in rotation on a user-screen, in the hope of generating a response. In fact, on some sites because of the limited inventory that may be displayed to a user, advertising space has been sold-out years into the future. Thus, the site operator is precluded from generating additional revenue barring change in the way advertising is currently practiced.

Advertising inventory will thus increase at the site following adoption of methodology according to embodiments of the invention. On account of the targeted delivery of advertisements, a site operator is now able to display a larger inventory of advertisements. This is because, better targeting leads to better click-through rates or user-responses, leading to more revenue for the site-operator for the same number of advertisements displayed. In addition, advertisers also benefit because there is a higher probability that a person shown an advertisement is actually a potential customer. A substantial increase in the revenue stream available to a site-operator is possible by adoption of methodologies in accordance with embodiments of the present invention.

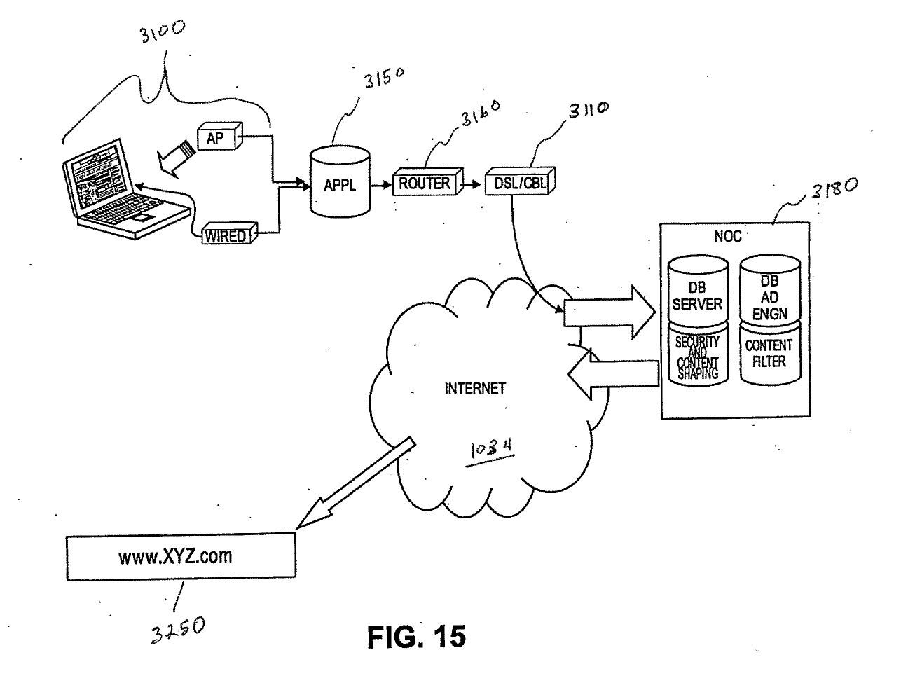

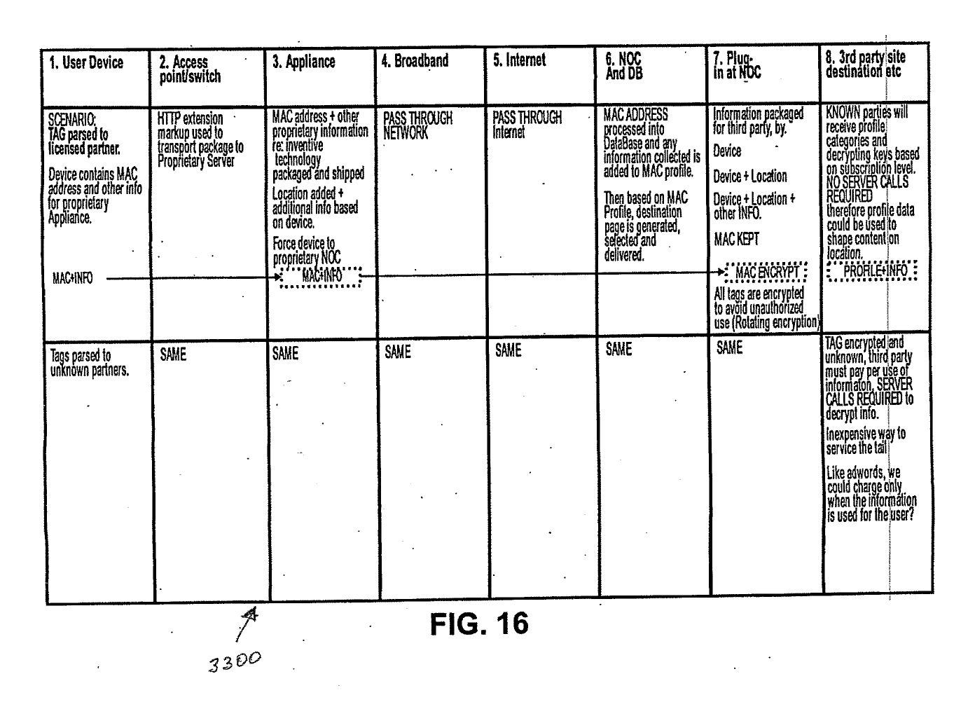

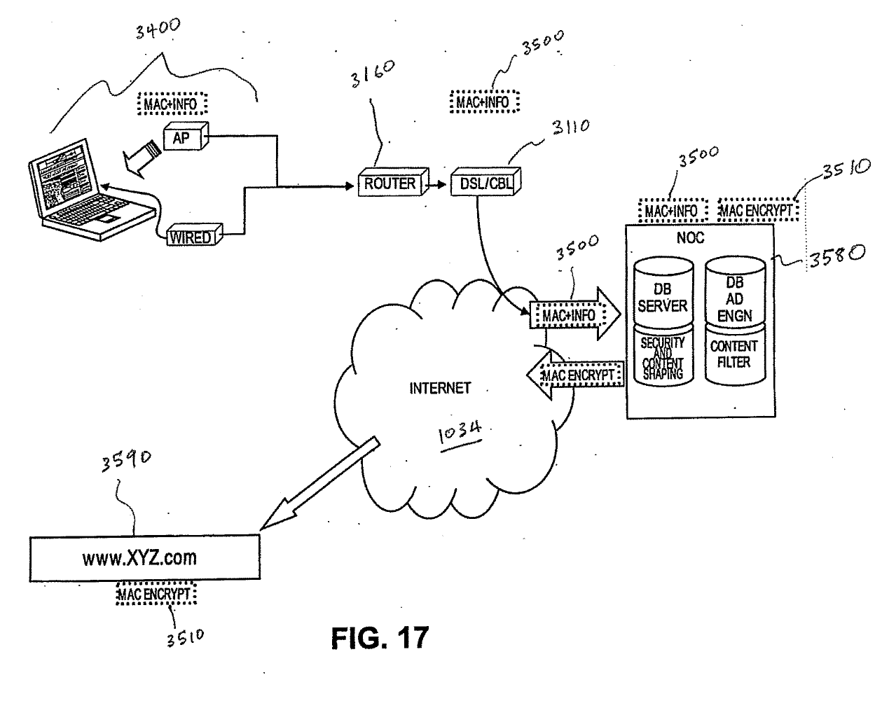

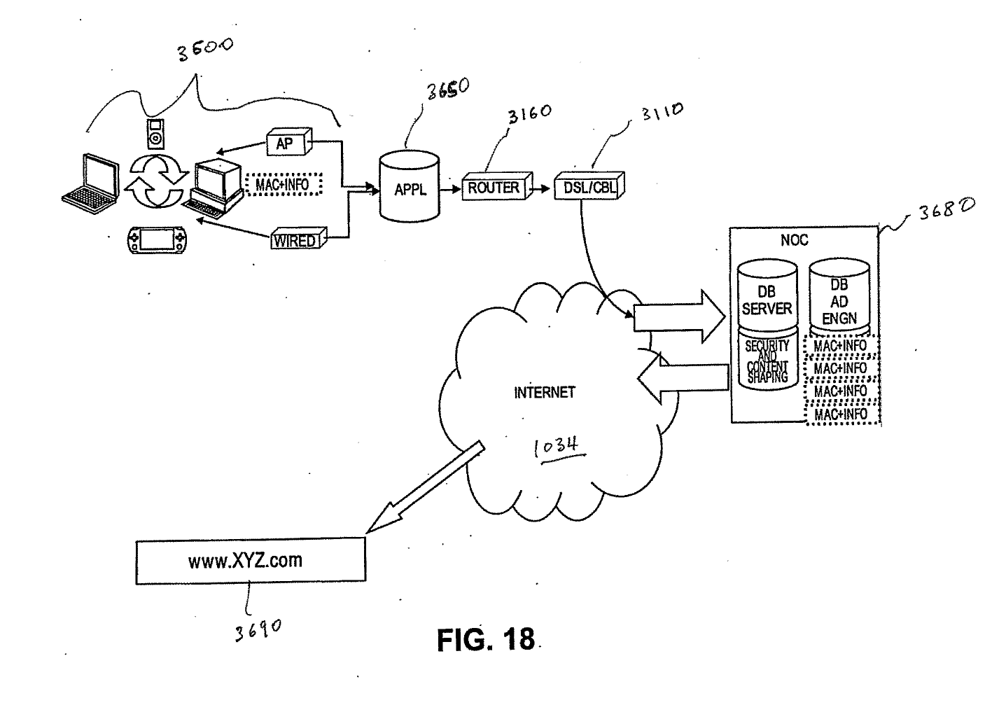

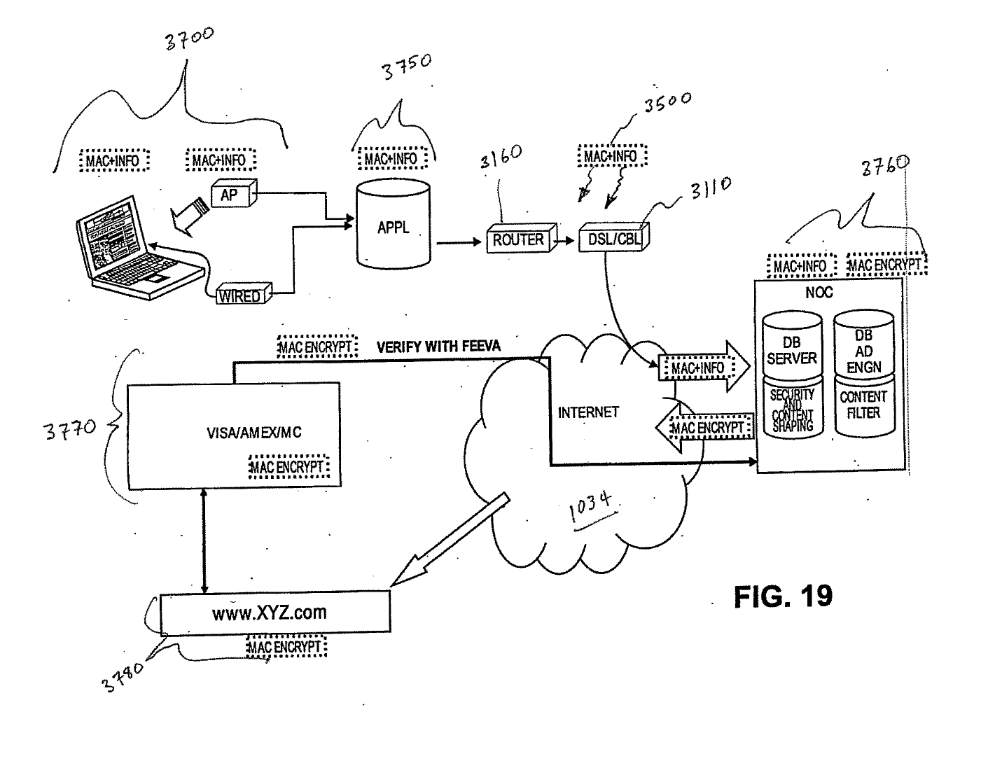

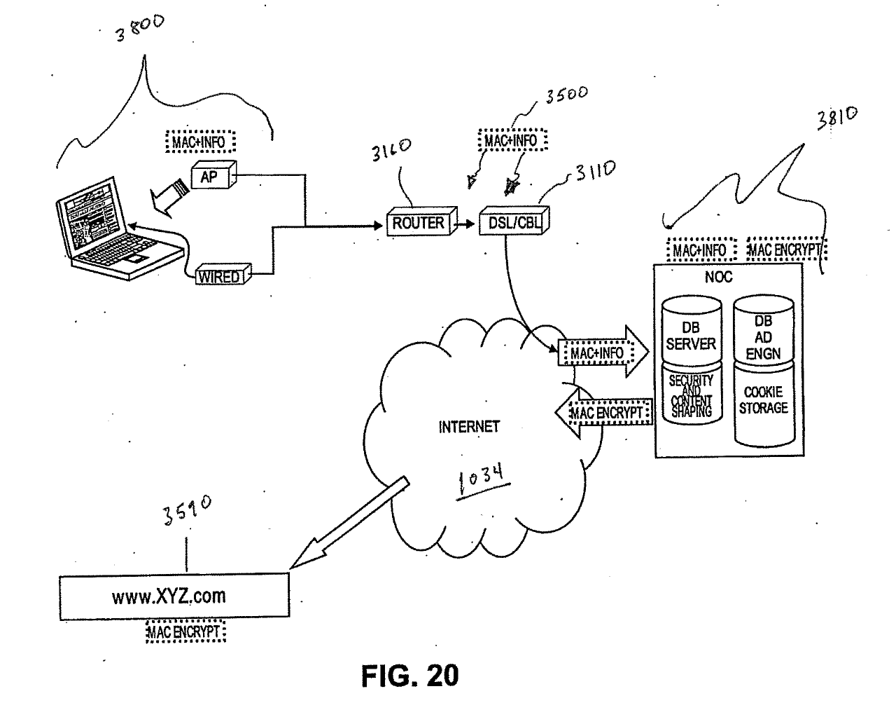

FIGS. 15-20 illustrate systems of method of network operation and information (MAC/UID) processing consistent with one or more embodiments of the present invention, as explained in more detail in Appendix B of the priority application, incorporated by reference in its entirety per above.

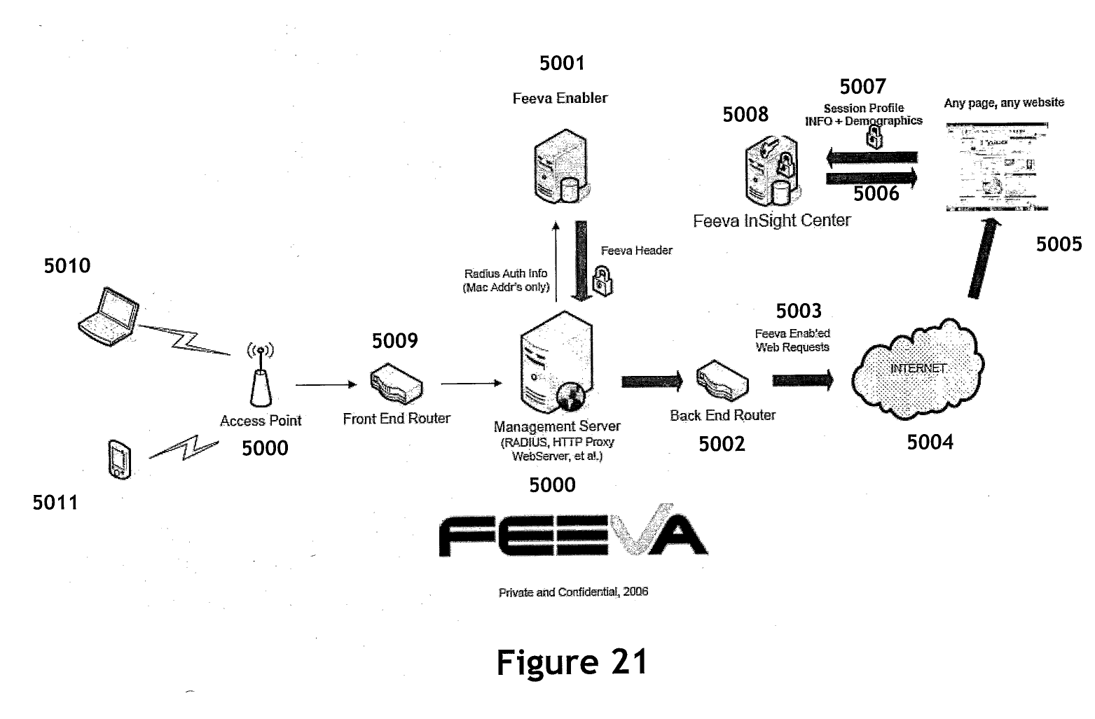

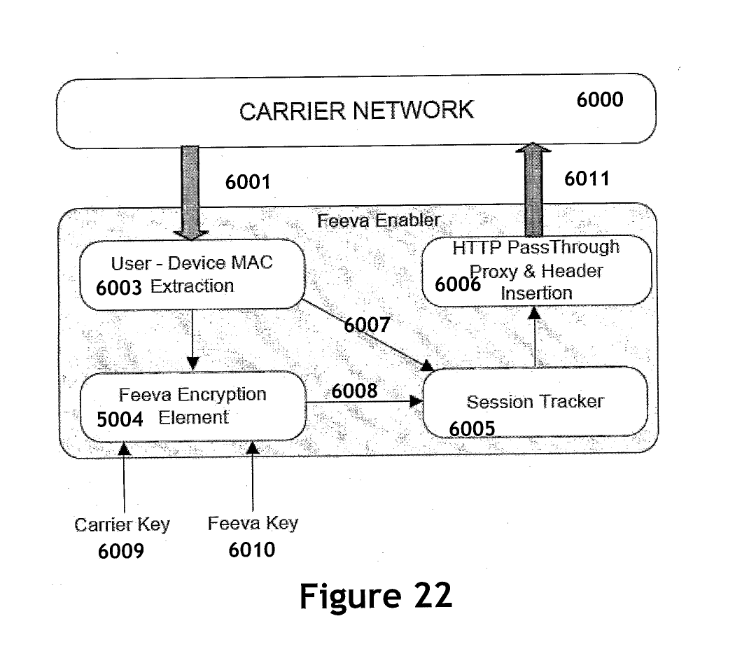

FIG. 21 illustrates systems and/or methods of an enabler for tagging profiles consistent with one or more embodiments of the present invention. FIG. 22 illustrates systems and/or methods of integration with Carriers networks consistent with one or more embodiments of the present invention. One or more embodiments of these systems and methods relate to processes communicating a persistent-globally-unique-identifier about a web-surfer/user to Internet destinations on a per request basis. In these embodiments, a methodology for communicating a persistent-globally-unique-identifier [persistent-guid] associated with a web-surfer, to Internet-destinations, is disclosed. The persistence of the id and the communication of it on a per session basis to any internet-destination are the key unique propositions of such a solution. The persistent-guid is based on the user device's unique hardware address, and is communicated to internet destination as an element of the conventional HTTP header package. Internet destinations can then utilize these (persistent-guid's) to perform customization & personalization of their internet real-estate. Such exemplary processes of communicating the persistent-guid can be broken down into the following steps: (1) Identifying the user device's hardware address, and creating a persistent-guid based on it; (2) Inserting this persistent-guid in the HTTP header for each request made by the user. This requires the installation of special software/hardware on the participating access network; (3) Providing internet destinations with standard easy-to-use tools to decipher these persistent-guid's upon their detection in the HTTP headers of incoming web requests; and (4) Maintaining a central repository (could be distributed) of these persistent-guid's to allow destinations to perform lookups and deposit information that they deem useful.

Embodiments of the invention relate to a business method using technology and methodology to combine the location-centric and user profile data in order to identify and suggest preferences, and deliver content to a user. Further, embodiments of the method also allow the content providers to accurately measure the frequency and locations to which a particular piece of information has been delivered. As a result, a content provider may accurately determine the effectiveness of a particular class of content, and be able to customize content such as language, format (e.g. colors, video, images, audio) etc. according to its desired demographic structures.

Embodiments of the invention also relate to business methods, which allow for the creation and/or identification of demographically alike but geographically dispersed communities and make targeted content delivery possible to these communities.

In some embodiments, the AP server may be comprised of: (1) a processor; (2) a configuration component/module; and (3) processing software; and (4) appropriate memory, storage, networking capabilities and associated peripherals. All of these elements can be unitary or distributed.

The access point configuration component/module can be a configuration module that includes setup configuration information uploaded prior to implementation, wherein the setup configuration information includes home page redirection information, XML-enabled interface information, and portal redirect with parameter passing information.

The access point processing software can include a redirection procedure/routine, wherein the processing software comprises a program of instructions instructing the processor to perform the steps of:

relaying a request from the user regarding access to the network including LOCAL DATA;

in response to the requester, receiving an authorization/T&C page from the server, and passing/providing this page to the user, wherein the one or more initial web pages includes information determined by the processing software as a function of the LOCAL DATA; and

opening up a connection for the user once the user has accepted the T&C; whereby connection of the user to the management server is implemented in association with the provision, by the access device, of LOCAL DATA (unique to the location and the user's MAC/UID), and usage authorization and provision of unique content based on the LOCAL DATA is enabled.

Further system and method implementations are detailed below, according to some embodiments of the present invention. These implementations are useful, for example, within the systems and methods characterized by implementing a UN engine server; deploying an access device into the network; requesting authorization to use the public-access network, including transmission of unique identification information for the user with the authorization request; transmitting data including a splash page having sponsor information (e.g., media), relevant information based on access device location, and/or terms and conditions for using the network, wherein the data to be transmitted is determined by the processing software as a function of the user's unique identification information; and transmitting instructions to open up a connection for that specific user.

Regarding, the wireless implementation addressed above, embodiments of the present invention provide advantages pertaining to direct access, location, traffic management, and network operations. With respect to direct access, the present invention provides direct connection to the customer and eliminates third party involvement in the delivery of content, as well as allowing the licensee, subscriber, or vendor to be the starting point of each and every communication (e.g., page, flash page, search, etc.) with the customer. With respect to location, the present invention provides the exact location of the customer, providing significantly greater value to advertising-related information and other content. In other words, focused encapsulated information about a customer is more valuable to advertisers desiring directed advertising and other communications. With respect to traffic considerations, the cost methodologies addressed herein provide for greater accessibility, as costs present a significant competitive barrier. Specifically, some embodiments of the present inventive methodology allow for the provision of free Internet access to end-users. Therefore, from a traffic maximization point of view, these embodiments are advantageous for networks such as those that are: (1) carrier class networks, (2) easy to log onto, and (3) ubiquitous. Finally, with respect to network operations, the present methodology provides relatively low equipment costs for access to customer information of this nature, as well as the capability of avoiding the expenses associated with implementing and/or managing a network of this size and quality.

The technology set forth herein, describing embodiments of the invention, has applicability to the operation of WiFi, WiMAX, DSL, Cable, IPTV etc networks, and to organizations closely associated with the deployment and provision of WiFi, WiMAX, DSL, Cable, IPTV etc technology. Systems and methods according to embodiments of the present invention provide numerous advantages in the areas of network management and operation, data collection and aggregation, real-time provision of user demographics, location and other information, and reporting of WiFi, WiMAX, DSL, Cable, IPTV etc network usage (for example, summaries, or aggregate statistics, even in real-time). The WiFi, WiMAX, DSL, Cable, IPTV etc embodiments described may have specific applicability to service providers, portals, and Internet ad intermediaries. For example, systems and methods according to embodiments of the present invention provide unique advantages to service providers like Voice over IP (“VoIP”) internet telephony companies, such as authentication/authorization of the telephones on log-in, logging of the calls for statistics and billing, network management (e.g., bandwidth, ports, etc.), and security management (e.g., firewall, eliminating unwanted third parties, etc.). Embodiments of the present invention also provide significant advantages to portals, such as real-time user demographics and location information that allow for immediate, directed advertising. Embodiments of the present invention also provide significant advantages to internet advertising intermediaries, such as information management applicable to all of the many layers of service providers involved in having an advertisement (such as a banner) displayed on a web page.

Other embodiments of the invention will be apparent to those skilled in the art from consideration of the specification and practice of the invention disclosed herein. It is intended that the specification and examples be considered as exemplary only, with a true scope and spirit of the invention being indicated by the disclosure above in combination with the following paragraphs describing the scope of one or more embodiments of the following invention. It should be known that use of the RAW DATA term below is representative of alternatives which are raw data, anonymized data, data which is clustered and collated according to business and syntax of filters related to business/marketing inputs from the advertising, content or search providers, and then only that information is launched to the these providers, not any of the raw data collected in the network.

1.-44. (canceled)

45. A system comprising:
a first processing component that receives an outbound request from a user to a target site; and
a second processing component that:
processes the outbound requests to generate profile data of the user;
stores the profile data in a data store; and
shares the profile data with a target site to facilitate transmission of directed media from the target site to the user;
wherein an identifier is derived based on the outbound request; and
wherein the identifier is associated with requests from the user.

46. The system of claim 45 or other claims herein, wherein the first processing receiving component is a routing/connectivity component.

47. The system of claim 45 or other claims herein, wherein the routing connectivity generates the identifier based on the outbound request and inbound data associated with one or both of a site or the target site.

48. The system of claim 45 or other claims herein, wherein the first processing component inserts identifier information regarding the user into the outbound requests.

49. The system of claim 45 or other claims herein, wherein the identifier is a tag, a MAC, or a unique identifier (UID).

50. The system of claim 45 or other claims herein, wherein the identifier includes identification information consistent with a cookie.

51. The system of claim 45 or other claims herein, wherein the first processing component receives/processes inbound data associated with user profiling functionality.

52. The system of claim 45 or other claims herein, wherein the second processing component includes a server.

53. The system of claim 45 or other claims herein, wherein the second processing component includes a Device and Targeting Database component.

54. A method comprising:
processing/intercepting outbound request from a user to a target site;
deriving an identifier based on the outbound request;
processing/intercepting/receiving inbound data/traffic/information responsive to the outbound request;
processing the outbound request to generate profile data of the user;
processing/accumulating/storing the profile data; and
sharing/transmitting the profile data with the target site to facilitate transmission of directed media from the target site to the user.

55. The method of claim 54 or other claims herein, wherein the inbound data is processed in association with generating the profile data.

56.-100. (canceled)

101. A system comprising:
a routing/connectivity device that receives an outbound request from a user to a target site; and
a device and targeting database server that:
processes the outbound requests to generate profile data of the user;
stores the profile data in a data store; and
shares the profile data with a target site to facilitate transmission of directed media from the target site to the user;
wherein the device and targeting database server is arranged to derive an identifier based on the outbound request, and to associate the identifier with requests from the user.

102. The system of claim 101, wherein the routing/connectivity device generates the identifier based on the outbound request and inbound data associated with one or both of a site or the target site.

103. The system of claim 101, wherein the routing/connectivity device inserts identifier information regarding the user into the outbound requests.

104. The system of claim 101, wherein the identifier is a tag, a MAC, or a unique identifier (UID).

105. The system of claim 101, wherein the identifier includes identification information consistent with a cookie.

106. The system of claim 101, wherein the routing/connectivity device receives and/or processes inbound data associated with user profiling functionality.

107. A method comprising:
processing/intercepting outbound request from a user to a target site;
deriving an identifier based on the outbound request;
processing/intercepting/receiving inbound data/traffic/information responsive to the outbound request;
processing the outbound request to generate profile data of the user;
processing/accumulating/storing the profile data; and
sharing/transmitting the profile data with the target site to facilitate transmission of directed media from the target site to the user.

108. The method of claim 107, wherein the inbound data is processed in association with generating the profile data.

109. A method comprising:
registering users logging-on to a computer network;
gathering user-related information from users;
relaying location-centric information to a server for a user logged-on to the network;
retrieving user-profile information for a user from a database based on user-related information;
processing the user-profile and/or location-centric information for the user to get targeting information for the user; and
sharing the targeting information to a content-provider wherein the content-provider uses the targeting information to select content to be displayed to users.

110. The method of claim 109, further comprising displaying selected targetable content, which is modified based on user a preference and/or a user profile, on a browser associated with the user.

111. The method of claim 110, wherein the targetable content includes results of a search query.

112. A method comprising:
storing an inventory of targetable content;
processing targeting information pertaining to users of a web site;
selecting targetable content for a user of the web-site based on the targeting information received for that user; and
transmitting the selected targetable content for display on a graphical interface of the user's.

113. The method of claim 112, wherein the selected targetable content is modified based on user-preferences.

114. The method of claim 112, wherein the selected targetable content t is modified based on parameters of the display being used by the web-site user.

115. The method of claim 112, wherein the selected targetable content is modified based on user a preference and/or a user profile.

116. The method of claim 112, wherein the targetable content includes results of a search query.

117. The method of claim 112, further comprising transmitting configuration information to modify display on the graphical interface based on a user preferences and/or a user profile.

118. The method of claim 112, wherein the selected targetable content includes web data or a result of a video or audio stream, and information is transmitted to modify the graphical interface based on a user preference and/or a user profile.
